(19) United States
(12) Patent Application Publication
(10) Pub. No.: US 2020/0202472 A1
(43) Pub. Date: Jun. 25, 2020

(54) ADAPTING WORKERS SAFETY PROCEDURES BASED ON INPUTS FROM AN AUTOMATED DEBRIEFING SYSTEM

(71) Applicant: NEW GO - ARC (2015) LTD., Motza Illit (IL)

(72) Inventors: Dror BARAK, Motza Illit (IL); Haim Ygal SRUR, Tel Aviv (IL); Hana GUR ARIE, Modi'in-Maccabim-Re'ut (IL); Zvika HARNIK, Rishon LeZion (IL); Yoram ELAZARY, Rishon LeZion (IL)

(21) Appl. No.: 16/809,862

(22) Filed: Mar. 5, 2020

Related U.S. Application Data
(63) Continuation-in-part of application No. 16/641,483.
(60) Provisional application No. 62/562,501, filed on Sep. 25, 2017.
(60) Provisional application No. 62/816,221, filed on Mar. 11, 2019.

(51) Int. Cl. G06Q 50/26; G06F 16/23; G06F 16/248; G06F 16/26; G06Q 10/06

(52) U.S. Cl. CPC G06Q 50/265; G06F 16/2379; G06N 20/00; G06F 16/26; G06Q 10/063116; G06F 16/248

(57) ABSTRACT

The present disclosure describes methods and systems for adapting a safety management system to changing risks. The methods and systems include receiving from a plurality of sensors information pertaining to an execution of a first task in the industrial environment by a first set of employees including a first employee; following a completion of the first task, presenting to the first employee a debriefing questionnaire pertaining to the execution of the first task; processing the debriefing responses to determine a new safety-related risk for at least one object; receiving details of a second task scheduled to take place in the industrial environment by a second set of employees including a second employee; determining that execution of the second task involves usage of the at least object; and generating for the second employee briefing information that includes new briefing data for mitigating risks in the execution of second task.

### CROSS REFERENCES TO RELATED APPLICATIONS

This application is a continuation-in-part of and claims priority from U.S. patent application Ser. No. 16/641,483 filed Feb. 24, 2020, which is a national phase application of International Patent Application No. PCT/IL2018/051066, filed on Sep. 23, 2018 and claims the benefit of priority of Provisional Patent Application No. 62/562,501, filed on Sep. 25, 2017. This application also claims the benefit of priority of Provisional Patent Application No. 62/816,221, filed on Mar. 11, 2019.

### BACKGROUND

### I. Technical Field

The present disclosure generally relates to improving the safety in industrial environments, and more specifically to systems, methods, and devices that initiate safety related actions based on determined risk of a task.

### II. Background Information

Workplace safety remains a crucial issue in many regions of the globe. The two main challenges most workplaces deal with on a daily basis are personal safety issues and process safety issues. Most personal safety issues are caused by the performance gap and the knowing-doing gap. The performance gap that exists between the accepted practice and actual execution is caused, at least in part, by unskilled workers with high turnover rates and lack of alertness to possible hazards. The knowing-doing gap exists in two levels, both in the worker level in the organizational level. The first, between the knowledge a worker has on work procedures and the way the worker actually acts. The second between the amount of data an organization has and the actual events it prevents. Typicality, the knowing-doing gap in safety is caused by the inability to see the whole picture in real-time and the failure separate the wheat from the chaff. The existence of the performance gap and the knowing-doing gap in workplaces is evident because despite training, same accidents are repeated.

Typically, process safety issues are caused when industrial apparatuses (e.g., machines, structures, silos, and more) are built, used, or maintained without complying with regulations. The goal of personal safety is protecting employees from injury and illness. In contrast, the goal of process safety is protecting capital assets and environment from catastrophic accidents and near misses, particularly structural collapse, explosions, fires, and toxic releases. These two challenges may be managed hand in hand because promoting personal safety can result in improvement in equipment and operational integrity and promoting process safety can result in lowering the risk of injury and human life loss.

With the rise of the Internet of Things (IoT), many workplaces are able to obtain a large amount of data monitoring different aspects in the workplace. Nevertheless, collecting all this data will not end personal accidents and process accidents, because current safety systems do not sufficiency account for the human factor. Moreover, current safety systems provide static instructions to employees while their tasks are dynamic in nature and the risk keep changes. Consequently, current safety systems fail to identify and address hazards before preventable accidents occur.

The disclosed systems and methods are directed to providing new solutions for creating a safe work environment that fundamentally takes into consideration the human factor. The suggested systems and methods continuously identify hazards by choosing relevant data originating from different sources, calculate the current risk score, and initiate actions to prevent personal accidents and process accidents.

### SUMMARY

According to embodiments of the present disclosure, methods and systems are provided for adapting a safety management system to changing risks. The methods and systems include: receiving from a plurality of sensors in an industrial environment task execution information pertaining to an execution of a first task in the industrial environment by a first set of employees including a first employee; following a completion of the first task, presenting to the first employee a debriefing questionnaire pertaining to the execution of the first task; obtaining from a first communications device debriefing-responses of the first employee to the debriefing questionnaire; processing the debriefing responses to determine a new safety-related risk for at least one object associated with the industrial environment used during the execution of the first task, wherein the object includes at least one of: an employee, a tool, a machine, a vehicle, a material; updating a safety database to include data pertaining to the new safety-related risk for the at least one object used during the execution of the first task; receiving details of a second task scheduled to take place in the industrial environment by a second set of employees including a second employee; determining that execution of the second task involves usage of the at least object used during the execution of the first task; retrieving from the safety database the data pertaining to the new safety-related risk for the at least one object; determining at least one new action for mitigating risks in the execution of second task based on the retrieved data; generating for the second employee briefing information for the second task that includes new briefing data indicative of the determined action; and presenting to the second employee the briefing information using a second communications device.

Consistent with other disclosed embodiments, non-transitory computer-readable storage media may store program instructions, which are executed by at least one processing device and perform any of the methods described herein.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments. In the drawings:

FIG. 1 is an illustration of an exemplary system for analyzing information collected from an industrial environment.

FIG. 2 is a block diagram that illustrates some of the components of the exemplary system of FIG. 1, consistent with the present disclosure.

FIG. 3 is a block diagram that illustrates an exemplary embodiment of a memory containing software modules, consistent with the present disclosure.

FIGS. 4A-4E are flowcharts of exemplary methods associated with the software modules of FIG. 3, consistent with the present disclosure.

FIG. 5 is a flowchart of an example process used by the exemplary system to prevent an accident in an industrial environment.

FIG. 6A-6C include screenshots illustrating different features of the exemplary system, consistent with the present disclosure.

FIGS. 7A-7D include screenshots illustrating embodiments of an exemplary user interface of a system for managing safety measures for employees using smart cards, consistent with the present disclosure.

FIG. 7E is a flowchart of an example method for managing safety measures for employees using smart cards, in accordance with some embodiments of the disclosure.

FIG. 7F is an illustration of an exemplary system for managing safety measures for employees using smart cards.

FIG. 8 is a diagram illustrating a plurality of information sources available to a safety management system, consistent with the present disclosure.

FIG. 9 is a diagram illustrating interconnection of the system of FIG. 1 with other modules, databases, and users, in accordance with the present disclosure.

FIGS. 10A-10E includes examples of graphic displays provided by a safety management system, in accordance with the present disclosure.

FIG. 11 is a flowchart of an example process for real-time location-based safety management within an industrial environment, in accordance with the present disclosure.

FIG. 12 is a flowchart of an example process for providing real-time safety information at a plurality of locations within an industrial environment, in accordance with the present disclosure.

FIG. 13 is an example user interface showing the “blue line” and the “black line” according to the HOP principle described in “The Impact of Human Resource Management on Organizational Performance: Progress and Prospects” by Becker at el.

FIG. 14 is a flowchart of an example process for adapting a safety management system to changing risks, in accordance with examples of the presently disclosed subject matter.

FIG. 15 include screenshots illustrating a part of debriefing for an employee on a user interface of a handheld communication device, in accordance with examples of the presently disclosed subject matter.

FIG. 16 include screenshots illustrating a part of a briefing for an employee on a user interface of a handheld communication device, in accordance with examples of the presently disclosed subject matter.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

The present disclosure is directed to preventing accidents (e.g., work accidents) in an industrial environment. As used herein, the term “industrial environment” refers to workplaces, establishments, or areas in which workers manufacture, produce, store, assemble, refine, construct, or otherwise change the composition, phase, physical and/or chemical characteristics of a material or fluid. Examples of industrial environments include but is not limited to factories, manufacturing plants, refineries, fabrication facilities, warehouses, construction areas, drilling rigs, offshore platforms, and more. Typically, each industrial environment may be associated with its own work procedures. The term “work procedures” refers to instructions for completing a task. For example, the work procedures may include written, illustrated, demonstrated and/or voice instructions that describe the safest and most efficient way for completing a task. In one case, the work procedures may include a step by step description of a process associated with a task and any deviation from that process may cause damage or loss.

Embodiments of the present disclosure include receiving details of a task scheduled to take place in the industrial environment. As used herein, the term “task” in the context of this disclosure refers to one or more actions done by at least one employee, who perform his/her work duties. The one or more actions may include: transporting material from one place to another, bringing a piece from an initial state to a final state, fixing a specific malfunction in a machine, and more. The task may be a routine task that is part of an employee's daily work, or a special task that is assigned to at least one employee in response to an arising situation in the industrial environment. The terms “worker” and “laborer” may also be used interchangeably in this disclosure with reference to an employee. The term “details of a task scheduled to take place” refers to any type of data that describes a task or data associated with the task. For example, the details of the task may include a description of the desired outcome of the task, a description of the cause of the task, a list of employees assigned to the task, and more. In one embodiment, the details of the task may be obtained by receiving a request form, such as a work order. In another embodiment, the details of the task may be obtained by receiving a malfunction report.

Embodiments of the present disclosure further include determining at least one characteristic of the task. As used herein, the term “characteristic of the task” refers to one or more features attributed to the task. Consistent with the present disclosure, the characteristic of the task may assist in making a task measurable and controllable. For example, the characteristic of the task may be associated with the amount of resources (e.g., financial, equipment, manpower, materials and tools) required to complete the task, the amount of man-hours required to complete the task, the expected length of the task, or the purpose and value of the task. In one embodiment, the characteristic of the task may include at least one of the following: estimated start time of the task, identity of employees expected to participate in the task, expected duration of the task, potential accidents associated with the task, potential accidents associated with the identity of employees, types of materials expected to be used in the task, and types of tools expected to be used in the task. The term “tool” refers to a manually operated device for performing a task. In the context of this disclosure, a tool can vary from a screwdriver and a jackhammer to a forklift truck and an excavator.

Embodiments of the present disclosure further include obtaining safety-related information associated with the task scheduled to take place in the industrial environment. As used herein, the term “safety-related information” refers to any type of information associated with the safety aspects of a task. Consistent with the present disclosure, the safety-related information may include work procedures associated with the task (e.g., the required safety measures for the task, the minimum number of people required to complete the task, etc.), information associated with an employee assigned to the scheduled task (e.g., information about an employee's current shift and previous shifts, information about the employee's qualifications and seniority, relevant employee's health information such as allergies, etc.), information associated with a location of the scheduled task (e.g., details of other tasks scheduled to take place at a same area, safety restrictions applied to the location, etc.), information associated with the scheduled task (e.g., the individual responsible for the task, the budget for the task, etc.), information associated with tools expected to be used in the scheduled task (e.g., a list of tools that can be used in this task, indication of permits required to operate certain tools, etc.), information associated with materials expected to be used in the scheduled task (e.g., a list of materials expected to be used in the task, restrictions associated with materials expected to be used in the task, etc.), information associated with a time of the scheduled task (e.g., deadline for completing the task, expected duration etc.), information about calendar events (e.g., information about holidays or special events, information about personal events of employees assigned to the task, etc.), information associated with the expected weather for the duration of the scheduled task (e.g., predicted rain falls, wind speed, etc.), information from periodic inspection tours (e.g., known locations of safety hazards, warnings on certain working tools, etc.), information associated with the industrial environment (e.g., infrastructure blueprints, machinery inventory, material inventory, general regulations and specific procedures, a risk analysis plan, etc.), and more.

Embodiments of the present disclosure further include obtaining real-time information indicative of human error of at least one employee associated with the task. As used herein, the term “real-time information”, in the context of this disclosure, refers to information associated with events that happened in the industrial environment and which is obtained by the system substantially while the events happen. In one embodiment, the system may receive the real-time information in less than about one minute from the time the information was captured. In other embodiments, the system may receive the real-time information in less than about 30 seconds, in less than about 15 seconds, in less than about five seconds, in less than about one second from the time the information was captured. An example type of real-time information that may be obtained is image data, e.g., from a closed-circuit television system. Other types of real-time information may be obtained from one or more cameras located in the industrial environment, one or more communication devices of employees in the industrial environment, wearable sensors on employees in the industrial environment, operational technology (OT) sensors, environmental sensors, sensors associated with working tools, and more. Consistent with the present disclosure, the real-time information may be indicative of human error of at least one employee associated with the task. In order to know that at least one employee made an error, the system may compare the obtained real-time information with the work procedures and/or with a predetermined behavior baseline for each employee associated with the task to determine if a deviation exists. For example, the system may know that after a certain material is added to a chemical reactor the mixture should be heated to 60° C. In this example, the system may initiate a remedial action when it obtains information indicating that the mixture is about to be heated to 90° C. Examples of real-time information may include detected changes in the performances of an employee assigned to the task, detected changes in planned locations of the task, detected changes in tools expected to be used in the task, detected changes in materials expected to be used in the task, detected changes in an expected start time of the task, detected changes in an expected weather during the task, detected changes in the operational integrity of apparatuses in the industrial environment, detected changes in the structural statuses of facilities in the industrial environment, and more.

The present disclosure further includes determining first synergy data safety-related information and task characteristics and determining second synergy data from the safety-related information and the real-time information. As used herein, the term “determining synergy data” refers to a process of cross-reference information from multiple sources and identifying events that may be unidentifiable when considering information from each source separately. For example, the first synergy data may include details of at least one handover event expected to happen while the task is taking place. The handover event may be an employee shift change during the task, a material change during the task, a tool change during the task, a supervisor change during the task, and a change from working during daytime and nighttime. For example, the second synergy data may include details on a situation in the industrial environment that deviates from work procedures of the industrial environment. For example, the industrial environment may have a number of work procedures for storing different materials. The second synergy data may include an indication that a worker had stored a material not where the material should have been stored.

Embodiments of the present disclosure further include determining a predicted risk score of the scheduled task and determining a change in the risk score of the task. As used herein, the term “risk score” refers to a score that can be assigned based on comparing synergy data to a risk predictor model. A risk score can have a standard value (e.g., a number) or a multi-value threshold (e.g., a line on a graph). The value of the risk score may correlate to the deviation, upwards or downwards, from a reference risk score associated with a specific task or a reference risk score associated with a general task. In certain embodiments, if a risk score is greater than a reference risk score, there is increased likelihood that an undesirable event that may involve damage (e.g., physical damages) to workers or machines will occur during or after the task. In some embodiments, the magnitude of a predicted risk score or the amount by which it exceeds a reference risk score may be indicative of the risk associated with a scheduled task. Consistent with the present disclosure, the system may receive real-time information and update the risk score based on events detected using the real-time information. When the actual risk score of a task is above a certain threshold, the system may initiate a remedial action to prevent a work accident. As used herein, the term “initiating a remedial action” generally refers to any action that the system triggers to prevent hazardous events in the industrial environment or to minimize the damage of such events. Examples of remedial actions, include transmitting location-based warning messages to employees, displaying the detected hazards on a personalized map, performing an automatic shutdown, and creating customized inspection tour based on the detected locations of the plurality of hazards.

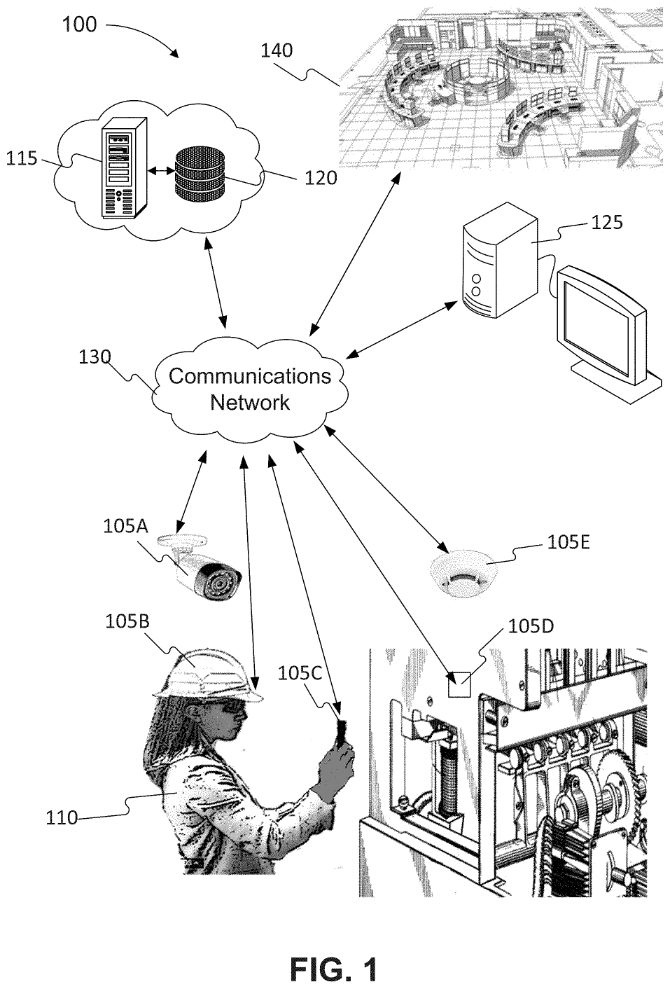

Reference is now made to FIG. 1, which shows an example of a system 100 for analyzing information collected from an industrial environment. In one embodiment, system 100 may represent a computer-based system that includes computer system components, desktop computers, workstations, tablets, handheld computing devices, memory devices, and/or internal network(s) connecting the components. System 100 may include or be connected to various network computing resources (e.g., servers, routers, switches, network connections, storage devices, etc.) necessary to support the services provided by system 100. In one embodiment, system 100 enables obtaining safety-related information associated with a task scheduled to take place in the industrial environment. In another embodiment, system 100 enables obtaining real-time information indicative of human error of at least one employee associated with the task.

System 100 may include at least one sensing device 105 that may (or may not) be associated with employee 110, a server 115 operatively connected to a database 120, and an output unit 125 associated with the industrial environment. The communication between the different system components may be facilitated by communications network 130.

Consistent with the present disclosure, system 100 may analyze data acquired by a plurality of sensing devices 105 to determine a risk score of a task and/or to identify hazards in the industrial environment. The term “sensing device” refers to any device configured to acquire data and to transmit data by wired or wireless transmission. In one embodiment, sensing device 105 may include any type of smart device that can acquire data used for deriving safety-related information or real-time information. The term “smart device” means an electronic device that is connected to another device or network via a wireless protocol, such as Bluetooth, NFC, Wi-Fi, 3G, LTE, etc. In one example, sensing device 105 may include an image capturing device, such as a fixed security camera 105A, autonomous robotic devices with cameras, drones with cameras, etc. In another example, sensing device 105 may include a wearable device, such as a smart helmet 105B, smart protective gear, smart glasses, a clip-on camera, etc. In another example, sensing device 105 may include a wireless communication device, such as a worker's handheld communication device 105C, a tablet, a mobile station, a personal digital assistant, a laptop, etc. In another example, sensing device 105 may include an operational technology sensor, such as OT sensor 105D that can measure various process parameters, such as temperature, pressure, flow, etc. in another example, sensing device 105 may include an environmental sensor 105E, such as smoke detector, anemometers, hygrometers, radiation detectors, etc. in another example, sensing device 105 may include a smart work tool (or a sensor connectable to a tool, thereby making the combined unit a smart work tool), such as a smart driller, smart excavator, etc. In addition, sensing device 105 may be configured to operate manually, remotely, or autonomously.

Sensing device 105 may exchange raw or processed data with server 115 via respective communication links. Server 115 may include one or more servers connected by network 130. In one example, server 115 may be a cloud server that processes data received from one or more sensing devices (e.g., sensing devices 105A-105E) and processes the data to determine a risk score of a task and/or to identify hazards in the industrial environment. Server 115 may also process the received data to determine recommendations for preventing accidents. The term “cloud server” refers to a computer platform that provides services via a network, such as the Internet. In another example, server 115 may be part of an off-line system associated with industrial environment that communicates with sensing device 105 using a wireless local area network (WLAN) or wire connections and can provide similar functionality as a cloud server. When server 115 is a cloud server it may use virtual machines that may not correspond to individual hardware. Specifically, computational and/or storage capabilities may be implemented by allocating appropriate portions of desirable computation/storage power from a scalable repository, such as a data center or a distributed computing environment. Server 115 may implement the methods described herein using customized hard-wired logic, one or more Application Specific Integrated Circuits (ASICs) or Field Programmable Gate Arrays (FPGAs), firmware and/or program logic which in combination with the computer system cause server 115 to be a special-purpose machine. According to one embodiment, the methods herein are performed by server 115 in response to a processing device executing one or more sequences of one or more instructions contained in a memory device. In some embodiments, the memory device may include operating system programs that perform operating system functions when executed by the processing device. By way of example, the operating system programs may include Microsoft Windows™, Unix™, Linux™, Apple™ operating systems, personal digital assistant (PDA) type operating systems, such as Apple iOS, Google Android, or other types of operating systems.

As depicted in FIG. 1, server 115 may be coupled to one or more physical or virtual storages such as database 120. Server 115 can access database 120 to process data to determine a risk score of a task, the determination occurring through analysis of data obtained from sensing devices 105. Server 115 can also access work procedures of the industrial environment stored in database 120 to determine if an identified situation in the industrial environment deviates from the work procedures. Database 120 may be a volatile or non-volatile, magnetic, semiconductor, tape, optical, removable, non-removable, or other type of storage device or tangible or non-transitory computer-readable medium. Database 120 may also be part of server 115 or separate from server 115. When database 120 is not part of server 115, database 120 and server 115 may exchange data via a communication link. Database 120 may include one or more memory devices that store data and instructions used to perform one or more features of the disclosed embodiments. In one embodiment, database 120 may include any suitable databases, ranging from small databases hosted on a workstation to large databases distributed among data centers. Database 120 may also include any combination of one or more databases controlled by memory controller devices (e.g., server(s), etc.) or software, such as document management systems, Microsoft SQL databases, SharePoint databases, Oracle™ databases, Sybase™ databases, or other relational databases.

Consistent with the present disclosure, sensing device 105 and/or server 115 may communicate with output unit 125 to present information derived from processing data acquired by sensing devices 105. For example, output unit 125 may display identified real-time hazards and potential hazards on a personalized map together with visual indicators of the hazard's severity and the hazard's type. In one embodiment, output unit 125 may be part of a factory manager station for controlling and monitoring the safety of a factory. In another embodiment, output unit 125 may be part of an employee station. Output unit 125 may be part of or connected to a desktop computer, a laptop computer, a PDA, a personal communication device, a dedicated terminal, etc. In this embodiment, system 100 may transmit location-based messages to output units 125 of employees located in proximity to a real-time hazard. In one example, the messages displayed on each output unit 125 may include a personalized location-based evacuation map showing the closest emergency exit.

Network 130 facilitates communications and data exchange between sensing device 105, server 115, and output unit 125 when these components are coupled to network 130. In one embodiment, network 130 may be any type of network that provides communications, exchanges information, and/or facilitates the exchange of information between network 130 and different elements of system 100. For example, network 130 may be the Internet, a Local Area Network, a cellular network (e.g., 2G, 2G, 4G, 5G, LTE), a public switched telephone network (PSTN), or other suitable connection(s) that enables system 100 to send and receive information between the components of system 100.

In addition, system 100 may also include a control room 140, in which one or more safety-managers, supervisors, managers, and other employees may convene for controlling safety aspects in the industrial environment. Such control room 140 may be equipped with one or more computers, one or more monitors (e.g., a large-screen monitors) and other user interfaces for provided safety-related data (and other data) from system 100, from database 120, or from other databases and systems (e.g., ERP) which include data relevant to safety in the industrial environment. The presented data may be modified in real time and may be presented based on automated system considerations as well as in accordance with requests and instructions of people in the control room. The user interfaces in control room 140 also enable people in the room to update the relevant safety management systems, to communicate with employees or employees of external contractors that work in the industrial environment, to decide on risk-mitigation actions and to see through to the execution of tasks and risk-mitigating steps, and so on.

Consistent with the present disclosure, a control room of an industrial environment (e.g., control room 140) may include a large-scale monitor or large scale smart white board (hereinbelow “control room screen”). In one embodiment, the control room screen may present real-time information be obtained from at least one of: a plurality of cameras located in the industrial environment, one or more communication devices of employees in the industrial environment, wearable sensors of employees in the industrial environment, operational technology (OT) sensors, environmental sensors, and sensors associated with working tools. Optionally, the control room screen may present information associated with tasks. For example, details on planned tasks, details on scheduled tasks, details on outstanding tasks, and details on recently completed tasks. In addition, the control room screen may present information associated with safety events, hazards, and/or potentials risks. For example, the control room screen may present details of recent hazards that were reported and treated or not treated yet. In addition, the smart control room screen present information about the employees that are actively working in a current shift. Optionally, the control room screen may have a feature of presenting a summary of events for assisting in shift replacement. Optionally, the control room screen may present to a manager of the industrial environment safety-related insights and operational excellence insights based on real-time information.

The components and arrangements shown in FIG. 1 are not intended to limit the disclosed embodiments, as the system components used to implement the disclosed processes and features can vary. For example, system 100 may include multiple servers 115, and each server 115 may host a certain type of service, e.g., a first sever that can process data retrieved from database 120 and determine a predicted risk score of a scheduled task, and a second server that can process real-time data received from sensing devices 105 and determine a actual risk score of a task taking place.

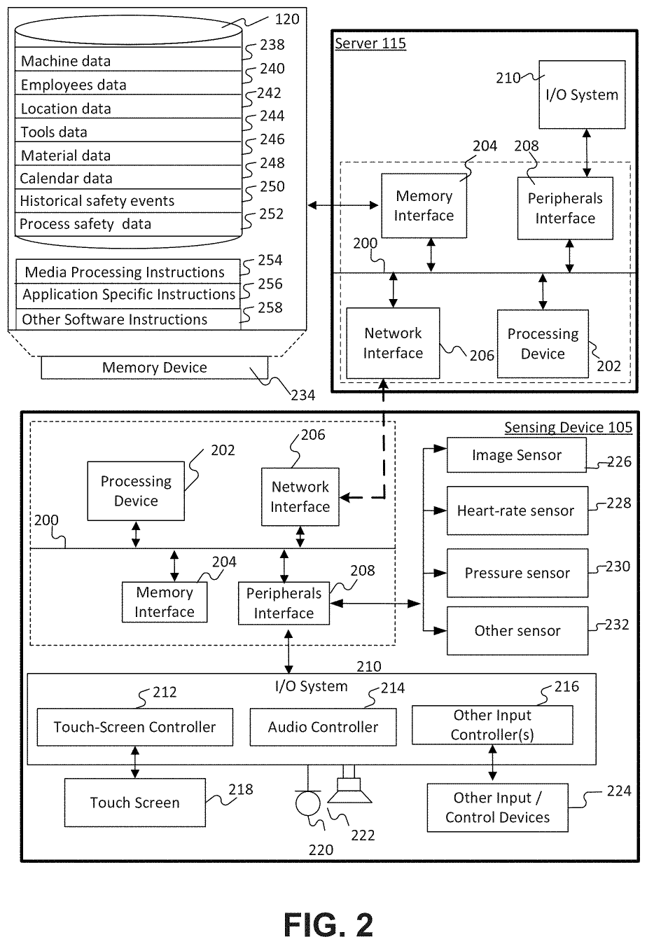

FIG. 2 is a block diagram of example configurations of server 115 and sensing device 105. In one embodiment, both server 115 and sensing device 105 includes a bus 200 (or other communication mechanism) that interconnects subsystems and components for transferring information within server 115 and/or sensing device 105. For example, bus 200 may interconnect a processing device 202, a memory interface 204, a network interface 206, and a peripherals interface 208 connected to I/O system 210.

Processing device 202, shown in FIG. 2, may include at least one processor configured to execute computer programs, applications, methods, processes, or other software to perform embodiments described in the present disclosure. The term “processing device” refers to any physical device having an electric circuit that performs a logic operation. For example, the processing device may include one or more integrated circuits, microchips, microcontrollers, microprocessors, all or part of a central processing unit (CPU), graphics processing unit (GPU), digital signal processor (DSP), field programmable gate array (FPGA), or other circuits suitable for executing instructions or performing logic operations. The processing device may include at least one processor configured to perform functions of the disclosed methods such as a microprocessor manufactured by Intel™ or manufactured by AMD™. The processing device may include a single core or multiple core processors executing parallel processes simultaneously. In one example, the processing device may be a single core processor configured with virtual processing technologies. The processing device may implement virtual machine technologies or other technologies to provide the ability to execute, control, run, manipulate, store, etc., multiple software processes, applications, programs, etc. In another example, the processing device may include a multiple-core processor arrangement (e.g., dual, quad core, etc.) configured to provide parallel processing functionalities to allow a device associated with the processing device to execute multiple processes simultaneously. It is appreciated that other types of processor arrangements could be implemented to provide the capabilities disclosed herein.

In some embodiments, processing device 202 may use memory interface 204 to access data and a software product stored on a memory device or a non-transitory computer-readable medium. For example, server 115 may use memory interface 204 to access database 120. As used herein, a non-transitory computer-readable storage medium refers to any type of physical memory on which information or data readable by at least one processor can be stored. Examples include random access memory (RAM), read-only memory (ROM), volatile memory, nonvolatile memory, hard drives, CD ROMs, DVDs, flash drives, disks, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The terms “memory” and “computer-readable storage medium” may refer to multiple structures, such as a plurality of memories or computer-readable storage mediums located within, server 115, sensing device 105, or at a remote location. Additionally, one or more computer-readable storage mediums can be utilized in implementing a computer-implemented method. The term “computer-readable storage medium” should be understood to include tangible items and exclude carrier waves and transient signals.

Both server 115 and sensing device 105 and may include network interface 206 coupled to bus 200. Network interface 206 may provide a two-way data communication to a local network, such as network 130. In FIG. 2 the communication between server 115 and sensing device 105 is represented by a dashed arrow. In one embodiment, network interface 206 may include an Integrated Services Digital Network (ISDN) card, cable modem, satellite modem, or a modem to provide a data communication connection to a corresponding type of telephone line. As another example, network interface 206 may include a local area network (LAN) card to provide a data communication connection to a compatible LAN. In another embodiment, network interface 206 may include an Ethernet port connected to radio frequency receivers and transmitters and/or optical (e.g., infrared) receivers and transmitters. The specific design and implementation of network interface 206 depends on the communications network(s) over which server 115 and sensing device 105 are intended to operate. For example, in some embodiments, sensing device 105 may include network interface 206 designed to operate over a GSM network, a GPRS network, an EDGE network, a Wi-Fi or WiMAX network, and a Bluetooth® network. In any such implementation, network interface 206 may be configured to send and receive electrical, electromagnetic or optical signals that carry digital data streams representing various types of information.

Both server 115 and sensing device 105 may also include peripherals interface 208 coupled to bus 200. Peripherals interface 208 be connected additional components or subsystems to facilitate multiple functionalities. In one embodiment, peripherals interface 208 may be connected to I/O system 210 configured to receive signals or input from devices and providing signals or output to one or more devices that allow data to be received and/or transmitted by server 115 and sensing device 105. In one example, I/O system 210 may include a touch screen controller 212, audio controller 214, and/or other input controller(s) 216. Touch screen controller 212 may be coupled to a touch screen 218. Touch screen 218 and touch screen controller 212 can, for example, detect contact, movement or break thereof using any of a plurality of touch sensitivity technologies, including but not limited to capacitive, resistive, infrared, and surface acoustic wave technologies as well as other proximity sensor arrays or other elements for determining one or more points of contact with the touch screen 218. Touch screen 218 can also, for example, be used to implement virtual or soft buttons and/or a keyboard. While a touch screen 218 is shown in FIG. 2, I/O system 210 may include a display screen (e.g., CRT or LCD) in place of touch screen 218. Audio controller 214 may be coupled to a microphone 220 and a speaker 222 to facilitate voice-enabled functions, such as voice recognition, voice replication, digital recording, and telephony functions. The other input controller(s) 216 may be coupled to other input/control devices 224, such as one or more buttons, rocker switches, thumbwheel, infrared port, USB port, and/or a pointer device such as a stylus.

With regards to sensing device 105 peripherals interface 208 may also be connected to different sensors. In one example, fixed security camera 105A and worker's handheld communication device 105C may include an image sensor 226 for capturing image data. The term “image sensor” refers to a device capable of detecting and converting optical signals in the near-infrared, infrared, visible, and ultraviolet spectrums into electrical signals. The electrical signals may be used to form an image or a video stream (i.e. image data) based on the detected signal. The term “image data” includes any form of data retrieved from optical signals in the near-infrared, infrared, visible, and ultraviolet spectrums. Examples of image sensors may include semiconductor charge-coupled devices (CCD), active pixel sensors in complementary metal-oxide-semiconductor (CMOS), or N-type metal-oxide-semiconductor (NMOS, Live MOS). In another example, smart helmet 105B may include a heart-rate sensor 228 for capturing an employee heart rate. In another example, OT sensor 105D may include a pressure sensor 230 that can measure a status of a machine in the factory. Other sensing devices may have other sensors connected to the peripherals interface 208 to facilitate related functionalities. In addition, a GPS receiver can also be integrated with, or connected to, sensing device 105.

Consistent with the present disclosure, server 115 may use memory interface 204 to access memory device 234. Memory device 234 may include high-speed random-access memory and/or non-volatile memory such as one or more magnetic disk storage devices, one or more optical storage devices, and/or flash memory (e.g., NAND, NOR). In some embodiments, memory device 234 may be included in, for example, server 115. Alternatively or additionally, memory device 234 may be stored in an external storage device communicatively coupled with server 115, such that one or more database (e.g., database 120) may be accessible over network 130. Further, in other embodiments, the components of memory device 234 may be distributed in more than one server.

In the illustrated example depicted in FIG. 2, memory device 234 hosts database 120. Consistent with embodiments of the present disclosure, database 120 may include data about the main five factors that generate a safe work environment. Specifically, database 120 includes machine data 238 (e.g., indications of the operational statuses of machines in in the industrial environment, such as scheduled repairs, maintenance requirements, and more)), employees data 240 (e.g., attendance data, records of training provided, evaluation and other performance-related communications, productivity information, qualifications, permits, previous safety events, and more), location data 242 (e.g., indications of areas in the industrial environment associated with certain safety restrictions and locations of specific safety-related features, such as the locations of fire extinguisher, electrical cabinet, and more), tools data 244 (e.g., indications of the operational statuses of each tool, a list of employees permitted to operate each tool, indications of the location of each tool, and more), material data 246 (e.g., indications of the storage statuses of machines in in the industrial environment, such as current temperature, transportation schedule, and more), calendar data 248 (e.g., holidays, national days, and more), historical safety events 250, and process safety data 252 (e.g., infrastructure blueprints, machinery inventory, material inventory, regulations about, for example, using and maintaining specific machines, a risk analysis plan, locations of known hazards, recommendations and/or restrictions associated with areas in the industrial environment, work procedures data that may stem from federal, state and local regulations, as well as from private initiatives such as total quality management and voluntary protection programs).

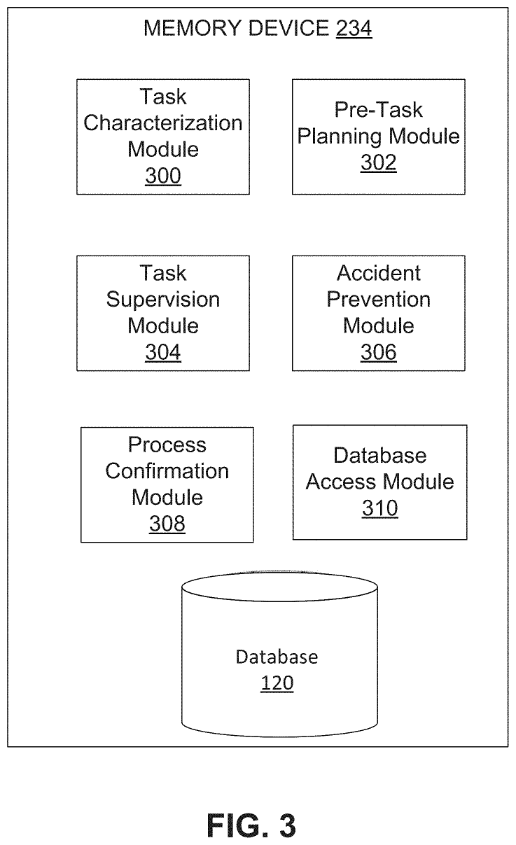

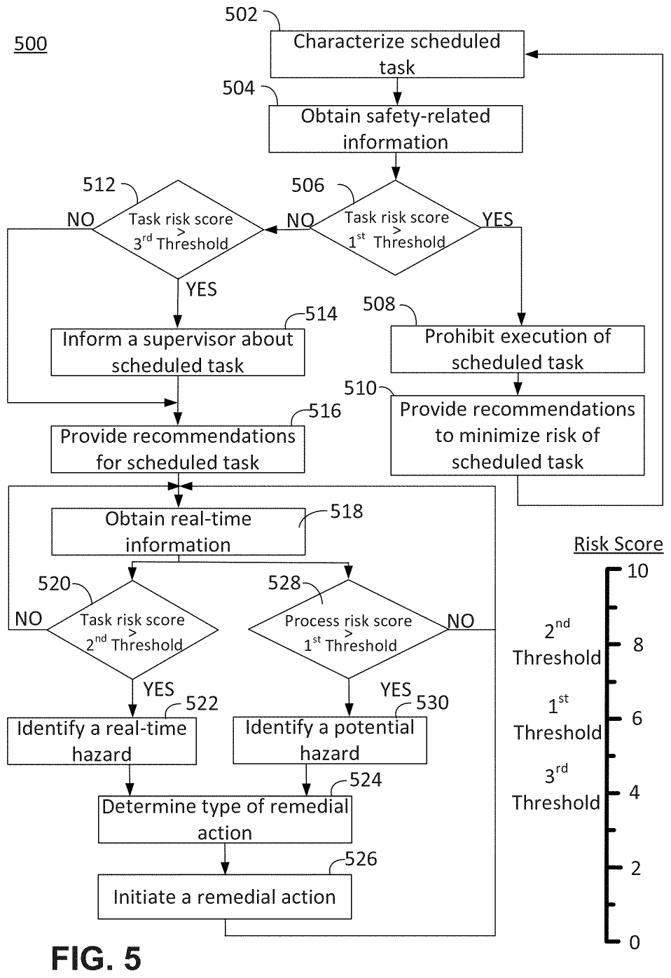

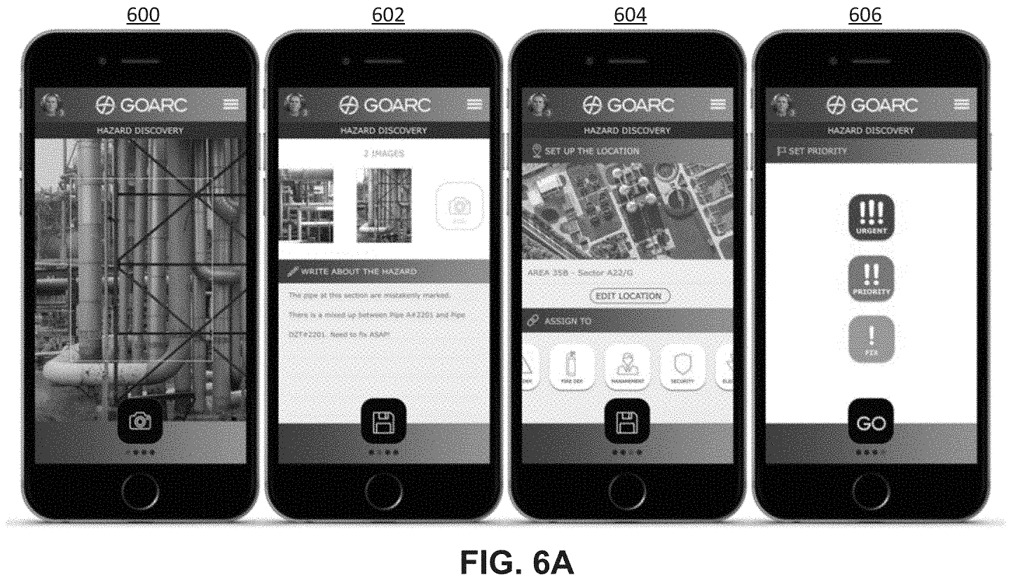

Consistent with the present disclosure, memory device 234 may also include media processing instructions 256 to facilitate media processing-related processes and functions, and/or other software instructions 258 to facilitate other processes and functions. Memory device 234 may also include application specific instructions 260 to facilitate a process for preventing an accident. An example process is described below with reference to FIG. 5. Memory device 234 may also include application specific instructions or modules to facilitate different processes for preventing accidents in the industrial environment. Example application specific modules are described below with reference to FIG. 3. In other embodiments of the disclosure, memory device 234 may store additional types of data or fewer types of data. Furthermore, various types of data may be stored in one or more other memory devices.

FIG. 3 illustrates an exemplary embodiment of a memory device 234 containing software modules consistent with the present disclosure. In particular, as shown, memory device 234 may include a task characterization module 300, a pre-task planning module 302, a task supervision module 304, an accident prevention module 306, a process confirmation module 308, and a database access module 310. Modules 300, 302, 304, 306, 308 and 310 may contain software instructions for execution by at least one processing device, e.g., processing device 202. Consistent with the present disclosure, task characterization module 300, pre-task planning module 302, task supervision module 304, accident prevention module 306, process confirmation module 308, database access module 310, and database 120 may cooperate to perform multiple operations. For example, task characterization module 300, pre-task planning module 302, task supervision module 304, accident prevention module 306, and process confirmation module 308 may be used to eliminate risk for personal and process work accidents on three levels:

Behavioral level—system 100 may eliminate risk from unforeseen dynamic risks by enforcing safe behavior even when workers do not see any indication that they may be in immediate risk (e.g., ladder stability, gasses and fumes, electricity, and more).

Non-isolated pre-task planning—system 100 may eliminate risks that can be known by expanding the analysis to other worker activities, worker conditions, work environments, and temporal changes. For example, system 100 may make workers and managers aware of the extended risks associated with outside factors (e.g., other tasks) to enable planning a scheduled task in a safe manner.

Real-time intervention—system 100 may detect that a change to the operating environment or a control indicator is not as expected (e.g., machine operational status, weather, other tasks, worker specific risk profile) or a combination of factors creates a risk score that is unacceptable. Thereafter, system 100 may initiate a remedial action, such as triggering real-time alerts, preventing the task from being performed by shutting down connected machines, or making the task paused or locked.

In one embodiment, task characterization module 300 may determine at least one characteristic of a task based on received details and historical safety-related information. Pre-task planning module 302 may determine that a predicted risk score of the scheduled task is below a first threshold, which means the task has a green light. Task supervision module 304 may use real-time information to determine that an actual risk score of the task has changed from the predicted risk score. For example, that the actual risk score is higher than the predicted risk score. Accident prevention module 306 may determine which appropriate remedial action is needed for preventing an accident and initiate the remedial action. Process confirmation module 308 may use information collected during task execution and confirm that the design integrity, the operational integrity, and the technology integrity comply with work process procedures. Database access module 310 may interact with database 120, which may store safety-related information and work procedures of the industrial environment and any other information associated with the functions of modules 300-310.

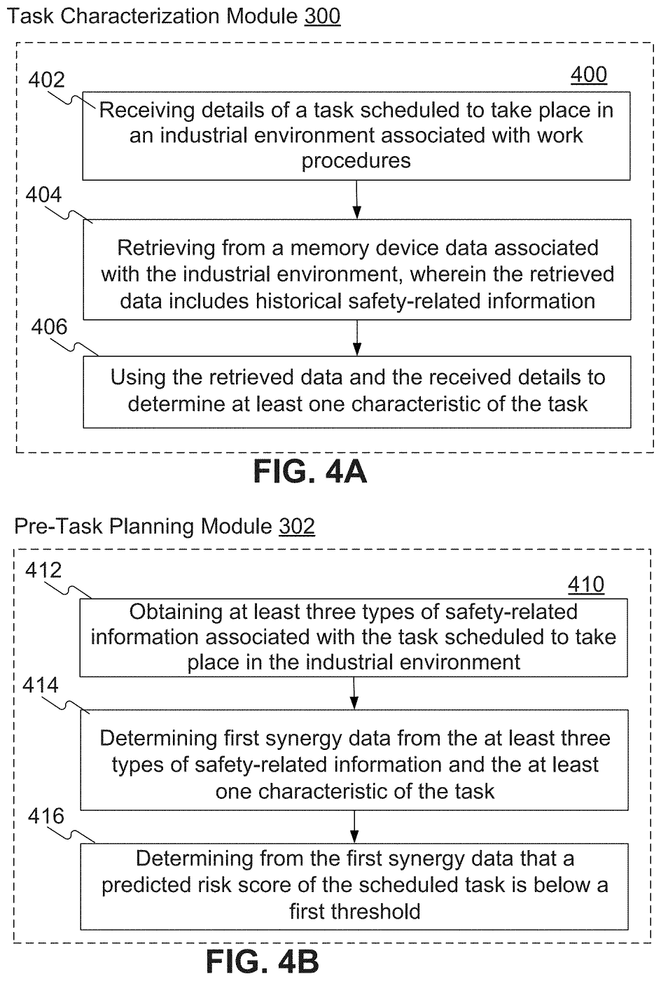

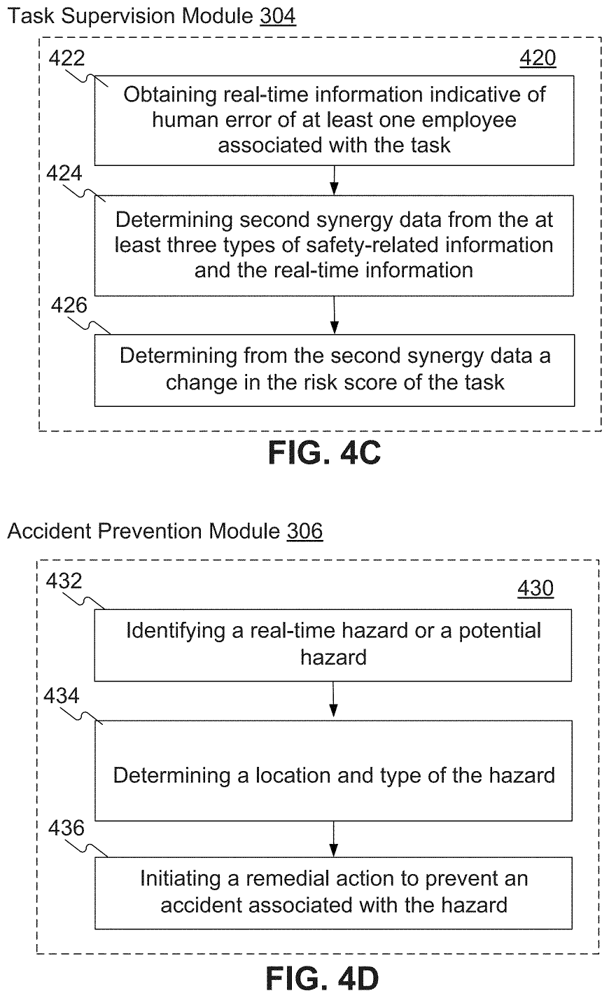

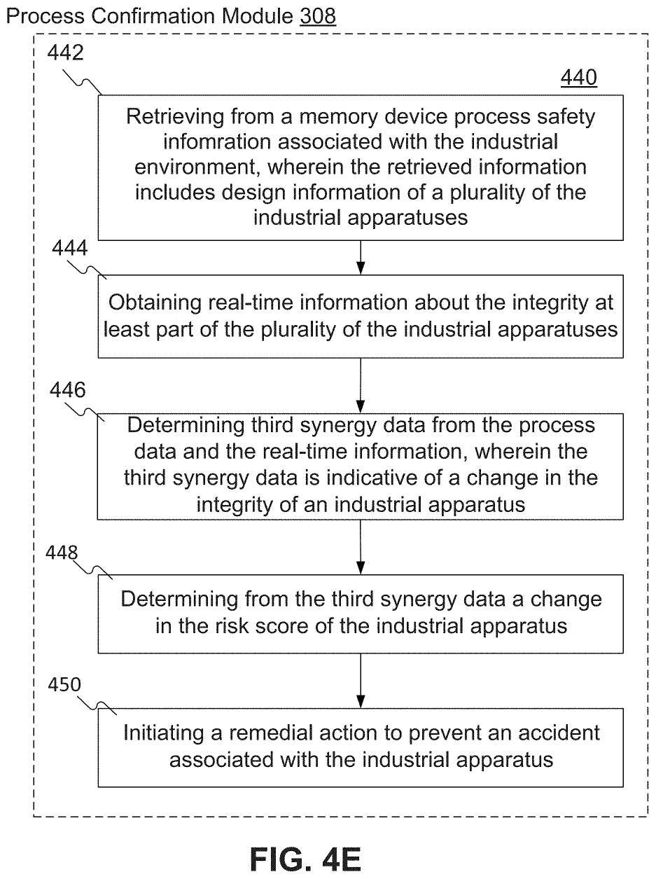

Reference is now made to FIG. 4A, which depicts an example method 400 that may be executed by task characterization module 300, consistent with the present disclosure. In one embodiment, all of the steps of method 400 may be performed by components of system 100. It will be appreciated, however, that other implementations are possible and that other components may be utilized to implement method 400. It will be readily appreciated that the illustrated method can be altered to modify the order of steps, delete steps, or further include additional steps.

At step 402, a processing device (e.g., processing device 202) may receive details of a task scheduled to take place in an industrial environment associated with work procedures. In one embodiment, the details of the task may be received by a network interface (e.g., network interface 206). At step 404, the processing device may retrieve from a memory device (e.g., memory device 234) data associated with the industrial environment. The retrieved data includes historical safety-related information (e.g., historical safety events 250). At step 404, the processing device may use the retrieved data and the received details to determine at least one characteristic of the task. Consistent with the present disclosure, the at least one characteristic of the task may include at least one of: estimated start time of the task, identity of employees expected to participate in the task, expected time duration of the task, type of tools expected to be used in the task, type of material expected to be used in the task, potential accidents associated with the task, potential accidents associated with the identity of employees.

At step 406, the processing device may use the retrieved data and the received details to determine at least one characteristic of the task. In one embodiment, the at least one characteristic of the task may relate to the properties of the task, such as work in confined space, work in height, or hot work. In another embodiment, the at least one characteristic of the task may relate to special environmental properties such as chemical, biohazard, radiation, pollution etc. The at least one characteristic of the task may be indicative of the type of physical or mental effort needed to complete the task. In addition, the task may be also be characterized by association with relation to other tasks taking place in the same or relevant proximity area or time. For example, another worker performing a task in height which changes the properties of the task of a worker on a lower level and who is exposed to a potentially falling object from above. In other examples, the task may also be characterized by it being done as part of a workplace routine or out of routine which may be unexpected to other people. In some cases, the task may also be characterized as its ability to spot leading indicators for a potential malfunction or crisis.

Reference is now made to FIG. 4B, which depicts an example method 410 that may be executed by pre-task planning module 302, consistent with the present disclosure. Similar to method 400, the steps of method 410 may be performed by components of system 100 and method 410 can be altered to modify the order of steps, delete steps, or further include additional steps.

At step 412, the processing device may obtain at least three types of safety-related information associated with the task scheduled to take place in the industrial environment. In some embodiments, the processing device may obtain and use at least two types of safety-related information, and in others at least four types of safety-related information. Consistent with one embodiment of the disclosure, the safety-related information may include information about each worker assigned to the task. Specifically, the worker performance may not be consistent and system 100 can account and predict for different causes for changed in the worker performance. For example, the level of concentration of the worker may vary when just starting a task versus after repeating it many times. People perform differently when they are just starting a shift versus when they want to finish a task and rush to go home. In addition, system 100 may consider impact of repetitive or sustained force, sustained or awkward posture, exposure to vibration or noise, restrictive movement space or clothing, restricted sensory perception, and more. System 100 may also determine if a worker may be tired, ill, under a restrictive diet or medication, under emotional stress, suffering from allergies, or just not accustomed to the task or environment such as the weather condition. In another embodiment, the safety-related information may include information about location of the task. Specifically, the location has many characteristics and system 100 can consider the restrictions associated with the planned locations of the scheduled task. For example, the location information may include area classification (class, zone), symbol for equipment classification, type of protection designations, gas identification group, temperature classification, ignition sources, and more. In another embodiment, the safety-related information may include information about the tools expected to be used in the task. Specifically, in many cases the way and how recently a tool or object was used may change the risk it presents to the worker and to the task quality. For example, the information about the tools may include an indication that a certain tool has overheated due to previous use, thus may still be a possible and unmitigated ignition source or alternatively a source for burns and injury; an indication that a tool may be equipped with incompatible or damaged fittings or connected to a power source other than expected; an indication that a tool may fall to a lower level; an indication that a tool also may be inappropriate to be operated with using the designated Personal Protective Equipment (PPE). In another embodiment the safety-related information may include information about materials expected to be used in the task. Specifically, different materials have different requirements for handling and for transporting, while some materials may change with time. The information may include details on materials that may evaporate, pressured by container changes, biomass gasses produced, radiation, and more. The information about materials expected to be used in the task may include details on the material, such as, measurements, expiration date, temperature restrictions, and more. In another embodiment the safety-related information may include information about the estimated start time of the task. Specifically, different temporal cycles may have different effect on the predicted risk score. For example, the information about the estimated start time of the task may include indications on the type of shift (day or night), time within a shift (start, mid or end), time of the day (even as it relates to light level or sun direction/visibility), time of high activity by other workers or lone worker.

At step 414 the processing device may determine first synergy data from the at least three types of safety-related information and the at least one characteristic of the task. In one embodiment, the first synergy data may include details of at least one handover event expected to happen while the task is taking place. As mentioned above, the handover event may be an employee shift change during the task, a material change during the task, a tool change during the task, a supervisor change during the task, and a change from working during daytime and nighttime. For example, the system may detect that during the task two of the workers are expected to be replaced (e.g., it is the end of their shift), this change will increase the risk score of the scheduled task. In another embodiment, the first synergy data may include details about a status change event associated with an asset of the retail environment. In one example, a status change event can happen when a machine goes back into service after being maintained or repaired. In another example, a status change event can happen when a day-shift employee is assigned to a night shift.

At step 416 the processing device may determine from the first synergy data that a predicted risk score of the scheduled task is below a first threshold. Consistent with the present embodiment, system 100 may determine the value of the risk score using the safety-related information, a plurality of rules, and a plurality of factors. The plurality of rules may include industry specific machine learning derived rules, location rules, worker risk analysis rules, policy rules, best practice rules, regulation rules, and more. The plurality of factors may include industry task risk analysis factors, environmental factors, timing factors, environmental risk factors, task statistics factors, and more. System 100 may use various machine learning or deep learning techniques to determine the the value of the risk score using the safety-related information, a plurality of rules, and a plurality of factors. In some embodiments, pre-task planning module 302 may determine the value of the risk score using past data, industry statistics, and operational parameters to predict the likely range of parameters that are likely to be present. For example, pre-task planning module 302 may predict the systematic and specific risk for each task at the planned time, place, worker, and activity scenarios. In one embodiment, for each scenario or task the pre-task planning module 302 may generate a risk score as well as a combined risk score with conjunction to other planned tasks in time or space proximity.

In some embodiments, pre-task planning module 302 may further includes instructions for causing the processing device to provide an employee associated with the task with pre-task planning information. For example, the employee may be a worker assigned to the task and the pre-task planning information includes personalized training based on past safety incidents included in the historical safety-related information; recommendations on how to execute the task according to the work procedures; information on existing hazards located in an area associated with the task; and information on potential hazards located in an area associated with the task. Alternatively, the employee may be a manager assigned to supervise the task and the pre-task planning information includes details about the task, such as the names and phone numbers of the workers that are assigned to the task.

Reference is now made to FIG. 4C, which depicts an example method 420 that may be executed by task supervision module 304, consistent with the present disclosure. Similar to method 400, the steps of method 420 may be performed by components of system 100 and method 420 can be altered to modify the order of steps, delete steps, or further include additional steps.

At step 422, the processing device may obtain real-time information indicative of human error of at least one employee associated with the task. The real-time information may be obtained from at least one of: a plurality of cameras located in the industrial environment, one or more communication devices of employees in the industrial environment, wearable sensors of employees in the industrial environment, operational technology (OT) sensors, environmental sensors, and sensors associated with working tools. In one embodiment the real-time information may include at least one, at least two, or at least three of: detected changes in the performances of an employee assigned to the task, detected changes in planned locations of the task, detected changes in tools expected to be used in the task, detected changes in materials expected to be used in the task, detected changes in an expected start time of the task, detected changes in an expected weather during the task, and detected deviation from the process safety procedures.

At step 424, the processing device may determine second synergy data from the at least three types of safety-related information and the real-time information. In one embodiment, the second synergy data may include details on a situation in the industrial environment that deviates from work procedures of the industrial environment. Example situations that deviate from normal operations work procedures may include times where there are training simulations or audits that divert workers and attention from normal activity. Other example situations may include times of extreme conditions, such as, natural extreme conditions (e.g., snow or storm or heat) personal work-related conditions (e.g., strike or social unrest). Other example situations may include changes in the work environment, such as renovation or maintenance taking place. In another embodiment the second synergy data may include details on a situation not caused by workers assigned to the task but still have a direct effect on the safety of the task. In a first example, the second synergy data may include identifying a vehicle transporting evaporating flammable materials that drives through an area where the task is executed. In a second example, the second synergy data may include identifying a change in weather conditions that may have an effect on the worker's performances (e.g., rain might change surface properties, making them slippery or create electricity hazards, dust and wind storms might impair workers' visibility and cause a worker to fall on the same level or to a lower level, strong wind might cause objects from levels above to come loose and fall or hit other objects or workers.) In a third example, the second synergy data may include identifying the movements of large vehicles and/or vehicles carrying unstable or extruding load in the area of the task.

At step 426, the processing device may determine from the second synergy data that an actual risk score of the task has changed from the predicted risk score. In one embodiment, the change in the risk score may be a decrease of the risk score due to the real-time event, which may trigger initiating a remedial action. In one example, a task of fixing a light pole in the industrial environment has received a risk score of 3.8 partially because there was rain prediction during the execution of the task. If system 100 detects that it does not rain during the task, it may decrease the risk score to 3.4. When the actual risk score is lower than the predicted risk score, the remedial action may include removing one or more measures or restrictions associated with the task. In one case, with reference to the example above, for tasks with a risk score higher than 3.5 remote supervision may be required but since the actual risk score is now lower than the threshold, system 100 may cancel the requirement of the remote supervision. In another case, also reference to the example above, when it is not raining, system 100 may inform the workers assigned to the task that they may use a ladder and not only a bucket truck. In another embodiment, the change in the risk score may also be an increase of the risk score due to the real-time event, which may trigger initiating a remedial action. One of the causes for an increase in the risk score may be detection of an event indicative of deviation from work procedures of the industrial environment. Different examples of remedial actions triggered when the change in the risk score is an increase of the risk score are discussed in greater details below.

Reference is now made to FIG. 4D, which depicts an exemplary method 430 that may be executed by accident prevention module 306, consistent with the present disclosure. Method 430 may be executed when the actual risk score of the task is above a certain threshold. Similar to method 400, the steps of method 430 may be performed by components of system 100 and method 430 can be altered to modify the order of steps, delete steps, or include further additional steps.

At step 432, the processing device may identify a real-time hazard and/or a potential hazard. The term “real-time hazard” refers to a cause of immediate danger associated with a place, a machine, a material, or a tool. Consistent with the present disclosure real-time hazards may have a personal safety source. In other words, a real-time hazard may be caused by a direct human action. In one example, a real-time hazard happens when a worker raises the heat in a machine above an auto ignition level for a chemical in proximity to the machine. In addition, ill maintained equipment and changing environment conditions may cause workers to improvise and not to perform as they should. These factors may cause personal accident while workers attempt to complete the task. For example, when the working environment is much hotter than usual, it may cause the eye protection glasses impossible to see through, so worker removes and is being exposed to danger. The term “potential hazard” refers to a cause of future danger associated with a place, a machine, a material, or a tool. Consistent with the present disclosure potential hazards may have a process safety source. In other words, a potential hazard may be caused by unplanned or unexpected deviations in process conditions. An example of a potential hazard happed when the structural integrity of a shipping container deteriorates and can cause a toxic waste leakage.

At step 434, the processing device may determine a location and a type of hazard. To determine the location of the hazard, system 100 may use any form of location tracking technology or locating method: location information manually inputted by a worker; Wi-Fi 33 server location data; Bluetooth based location data; any form of Global Positions Systems (e.g., GPS accessed using Bluetooth or GPS accessed using any form of wireless and/or non-wireless communication); any form of network based triangulation (e.g., Wi-Fi server information based triangulation, Bluetooth server information based triangulation; cell identification based triangulation, enhanced cell identification based triangulation, uplink-time difference of arrival (U-TDOA) based triangulation, time of arrival based triangulation, angle of arrival based triangulation); any form of systems using a geographic coordinate system (e.g., longitudinal and latitudinal based, geodesic height based, Cartesian coordinates based); any form of radio frequency identification systems (e.g., long range RFID, short range RFID; active RFID tags, passive RFID tags, battery assisted passive RFID tags). To determine the type of the hazard, system 100 may use artificial intelligence (AI) and machine learning algorithms. The types of the hazards may include electrical hazards (e.g., frayed cords, missing ground pins, and improper wiring); machinery-related hazards (e.g., exposed moving machinery parts, and safety guards removed); tripping hazards (e.g., cords running across the floor, and wet floor); height-related hazards (e.g., unsafe ladders, scaffolds, roofs, and any raised work area); biological hazards (e.g., fungi/mold, insect bites, animal and bird droppings); physical hazards (e.g., exposure to radiation, extreme temperatures, and noise); chemical hazards (e.g., spilled liquids, exposure to toxic fumes, explosive chemicals not stored properly, and more). The present disclosure is not limited to the listed-above types of hazards, additional types or different categorizations are encompassed in this disclosure.

At step 436, the processing device may initiate a remedial action to prevent an accident associated with the detected hazard. Consistent with the present disclosure, the remedial action may prevent of a series of incidents associated with personal safety or a catastrophic incident associated with process safety. In one embodiment, initiating the remedial action may include identifying an employee that is responsible for handling the determined type of hazard; and transmitting a message to the identifying employee, wherein the message may include the location of the hazard (e.g., the message may include an indication of the actual risk score and the GPS location of the hazard). In another embodiment, initiating the remedial action may include identifying an employee located within a distance of the hazard, wherein the distance is determined based on type of the hazard (e.g., for gas leakage the distance may be greater than wet floor). Thereafter, system 100 may transmit a location-based warning to the identified employee. In another embodiment, initiating the remedial action may include identifying an employee located within a distance of the hazard, and transmitting a personalized location-based evacuation map to the identified employee (e.g., the personalized location-based evacuation map may provide guidance to the closest exit). In another embodiment, initiating the remedial action may include identifying an employee located within a distance of the hazard, and transmitting instructions on how to fix or avoid the hazard to the identified employee (e.g., the instructions may be according to the work procedures of the industrial environment). In other embodiments, initiating the remedial action may include displaying detected hazards on a personalized map together with a visual indicator of the hazard's severity, performing an automatic shutdown to prevent predicted injuries or damages, or creating a customized inspection tour based on detected locations of a plurality of potential hazards and real-time hazards.

Reference is now made to FIG. 4E, which depicts an example method 440 that may be executed by process confirmation module 308, consistent with the present disclosure. Similar to method 400, the steps of method 440 may be performed by components of system 100 and method 440 can be altered to modify the order of steps, delete steps, or further include additional steps.

At step 442, the processing device may include retrieving from a memory device (e.g., database 120) process safety information (e.g., process safety data 252) associated with the industrial environment. In one embodiment, the retrieved information may include design information of a plurality of the industrial apparatuses. As mentioned above, the industrial apparatuses may include machines, structures, facilities found in the industrial environment.

At step 444, the processing device may obtain real-time information about the integrity at least part of the plurality of the industrial apparatuses. The real-time information may be obtained from at least one of: a plurality of cameras located in the industrial environment, one or more communication devices of employees in the industrial environment, wearable sensors of employees in the industrial environment, operational technology (OT) sensors, environmental sensors, and sensors associated with working tools. The real-time information may include indications of employees' actions that deviate from the process safety procedures.

At step 446, the processing device may determine third synergy data from the process data and the real-time information. In one embodiment, the third synergy data is indicative of a change in the integrity of an industrial apparatus. For example, the change in the integrity of an industrial apparatus may include at least one change in the design integrity, the operational integrity, and the technology integrity.

At step 448, the processing device may determine from the third synergy data a change in the risk score of the industrial apparatus. In one embodiment, the change in the risk score may be an increase of the risk score due to the real-time event, which may trigger initiating a remedial action. In one example, a risk score of a silo may increase when the system detects a corrosion in one of the pipes entering to the silo.

At step 450, the processing device may initiate a remedial action to prevent an accident associated with the industrial apparatus. In one embodiment, initiating the remedial action may include identifying an employee that is responsible for industrial apparatus; and transmitting a message to the identifying employee, wherein the message may include the status of the industrial apparatus. In another embodiment, initiating the remedial action may include identifying an employee located within a distance of the industrial apparatus, wherein the distance is determined based on type of the hazard associated with the industrial apparatus (e.g., for gas leakage the distance may be greater than wet floor). Thereafter, system 100 may transmit a location-based warning to the identified employee. In another embodiment, initiating the remedial action may include identifying an employee located within a distance from the industrial apparatus, and transmitting a personalized location-based evacuation map to the identified employee (e.g., the personalized location-based evacuation map may provide guidance to the closest exit). In another embodiment, initiating the remedial action may include identifying an employee located within a distance from the industrial apparatus, and transmitting instructions on how to fix or avoid the industrial apparatus to the identified employee (e.g., the instructions may be according to the work procedures of the industrial environment). In other embodiments, initiating the remedial action may include performing an automatic shutdown of the industrial apparatus to prevent predicted injuries or damages, or creating a customized inspection tour based on determined risk of the industrial apparatus.

FIG. 5 depicts a flowchart of an example process 500 executed by a processing device of system 100 (e.g., processing device 202) for preventing a work accident, according to some embodiments. Process 500 includes comparing the risk score to three different thresholds. The term “threshold” is used here to denote a reference value, a level, a point, or a range of values, for which when the calculated risk score is above it the processing device may follow a first course of action and when the calculated risk score is under it the processing device follows a second course of action. The value of each of the thresholds may be predetermined for each industrial environment or dynamically selected based on the task. An example risk scale with exemplary thresholds is also depicted in FIG. 5. Additional details about specific steps of process 500 are described above.

The process begins when the processing device characterizes a scheduled task (block 502). Thereafter, the processing device may obtain safety-related information (block 504) and use the safety-related information and the task characteristic to determine if a task risk score of the scheduled task is above a first threshold (decision block 506). When the task risk score of the scheduled task is above the first threshold, the processing device may issue a notice prohibiting the execution of the scheduled task (block 508) and provide recommendations to minimize the risk of the scheduled task (block 510). Thereafter, the process may continue when the processing device re-characterizes the task to check if any of the recommendations were implemented and the task risk score of the scheduled task is below the first threshold.

When the task risk score of the scheduled task is below the first threshold, the processing device determines if the task risk score of the scheduled task is above a third threshold (decision block 512). When the task risk score of the scheduled task is above the third threshold, the processing device may issue inform a supervisor about the scheduled task (block 514). Specifically, when the predicted task risk score of the scheduled task is below the first predetermined threshold and above the third predetermined threshold, the method may include informing one or more individuals that a risky task is about to take place. Process 500 continues when the processing device provides recommendations for a scheduled task (block 516). In one embodiment, the recommendations for a scheduled task may include checklists, relevant warnings, suggested tools, and more. In one example, the recommendations for scheduled task may include a safety exam that employees assigned to the task are required to complete. The process continues when the task actually starts, as the processing device obtains real-time information (block 518). The real-time information may be indicative of personal safety issues (e.g., the employee's actions) and also may be indicative of process safety issues (e.g., a change in a machine condition).

After obtaining the real-time information, process 500 splits to two paths that later converge. In the first path, the processing device determines if the actual task risk score is above a second threshold (decision block 520). As long as the actual task risk score is below the second threshold, the process continues with obtaining additional real-time information and monitoring the actual task risk score. When the task risk score is above the second threshold, the processing device may identify a real-time hazard (block 522), determine the type of remedial action needed based on the identified type of hazard (block 524), and initiate a remedial action to prevent an accident from happening (block 526). In the second path, the processing device determines if the process risk score is above the first threshold (decision block 528). In this context, the first threshold represents a level of risk that above it the system will prohibit execution of specific tasks. The actual value of the first threshold may differ from task risk scores and process risk scores. As long as the process risk score is below the first threshold, the process continues with obtaining additional real-time information and monitoring the process risk score. When the process score is above the first threshold, the processing device may identify a potential hazard (block 530) and initiate a remedial action to prevent an accident from happening (block 526). Consistent with the present disclosure, the system may initiate different actions when the identified hazard is associated with personal safety and when the identified hazard is associated with process safety.

Consistent with some embodiments, process 500 discloses a specific method for determining if a risk score associated with a task is above different thresholds. However, a person of ordinary skill in the art would recognize that process 500 may be easily adapted to identify when a risk score of an ongoing task departs from an acceptable range of risk scores associated with the characteristic of the task. Therefore, it will be readily appreciated that the process illustrated in FIG. 5 can be altered to modify the order of steps, delete steps, or further include additional steps. For example, the order of decision block 506 and decision block 512 may be switched.

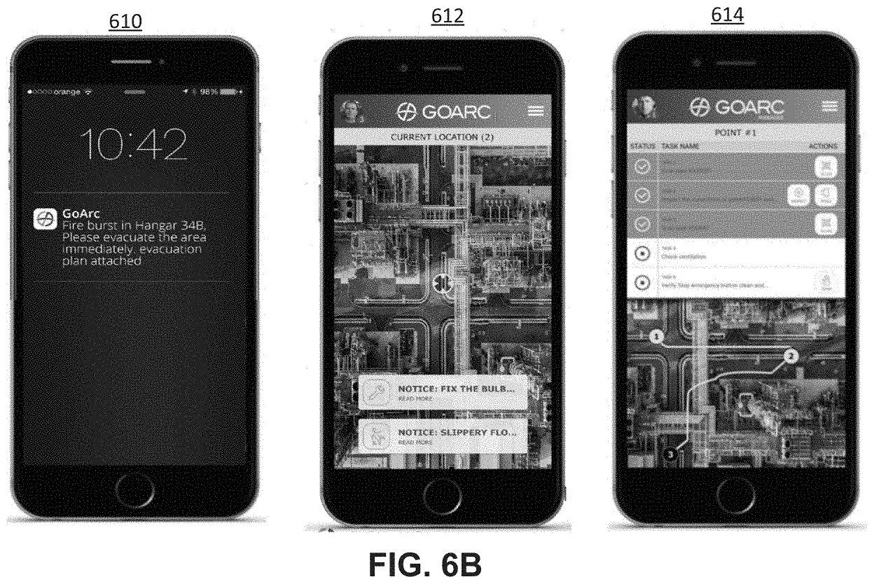

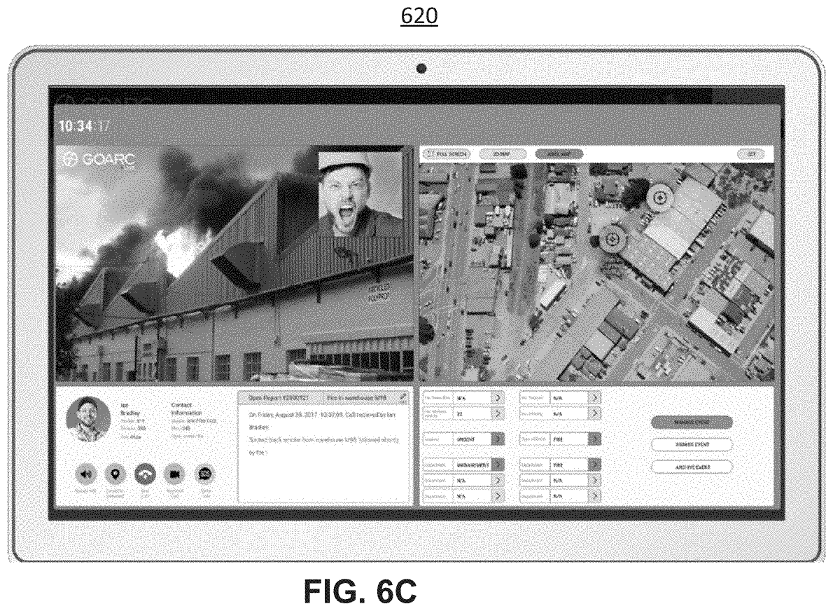

FIGS. 6A-6C illustrate screenshots depicting different embodiments of the present disclosure. The screenshots may be displayed in different components of system 100 of FIG. 1, such as handheld communication device 105C and output unit 125. FIG. 6A depicts four screenshots that illustrate the process of reporting a hazard by an employee of the industrial environment. FIG. 6B depicts three screenshots that illustrate different types of notices that system 100 may provide to employees of the industrial environment. And FIG. 6C depicts a single screenshot illustrating how system 100 can assist in managing an on-going emergency event.

FIG. 6A depicts example screenshots 600, 602, 604, 606 that illustrate the process of reporting a hazard by an employee of the industrial environment. In one embodiment, each employee (or another person) may be required to download a dedicated application associated with the industrial environment to a handheld communication device 105C used by the employee. The application may monitor the location of the employee—as well as other optional parameters—while the employee is within an area associated with the industrial environment. In addition, the application may enable employees to report safety hazards they detect during their daily work. For example, the application may enable the employee to take one or more pictures of the hazard (e.g., screenshot 600), add written description of the hazard (e.g., screenshot 602), provide the location of the hazard (e.g., screenshot 604), and set the priority of the hazard (e.g., screenshot 606). In one embodiment, system 100 may determine the priority level associated with a reported event and use differently the information from the reports based on the priority level. For example, reports of events at a high priority level may be considered real-time information that may change the actual risk score of tasks currently being executed. In contrast, reports of events at a low priority level may be considered safety-related information that may change the predicted risk score of a task scheduled to take place. It is noted that in addition to safety hazards, the employee may use their handheld communication device 105C to report other things (e.g., events, state of machinery, etc.) in the industrial environment, which are not safety hazards in themselves. Such reports may be combined by system 100 (e.g., by server 115) with other reports and/or other types of data to identify safety hazards which are a combination of several things. For example, an employee may report an amount of safety goggles in a lab, which is sufficient for the people presently and routinely working in the lab and is therefore not a safety hazard. However, server 115 may cross this report with a work permit indicating that a large group of visitors is expects to visit the lab later that day and prompt an alert to supply that lab with additional goggles for that day.

FIG. 6B depicts examples of screenshots 610, 612, and 614 that illustrate different types of notices that system 100 may provide to workers of the industrial environment. Specifically, screenshot 610 illustrates a push notification that the employee may receive while his/her smartphone (or another type of handheld communication device 105C) is locked. Typically, push notifications may be used only when an emergency situation occurs. Screenshot 612 illustrates location-based notices. The location-based notices (also referred to herewith as “location-based messages” or “location-based warnings”) may be indicative of hazards located less than a predefined distance from the current location of the employee and may be specific to the employee role. For example, a maintenance personnel may receive a notice for fixing a light bulb less than 200 meters from his/her current location, and a cleaning personnel might receive a notice for fixing a wet floor less than 150 meters from their current location. Screenshot 612 illustrates a location-based personalized checklist. The personalized checklist informs the employee of actions needed to be executed in the employee's current location in order to comply with the task objective and/or work process procedures. The location-based warnings may also be based on location in more complex ways, such as depending on the number of doors between the employee and a safety event, depending on relative heights (e.g., floors) between the employee and a piece of machinery, and so on.

FIG. 6C depicts example screenshot 620 illustrating how system 100 can assist in managing an on-going emergency event. In response to a distress call from one of the employees, system 100 may cause a display of two screens for managing the emergency event. The left screen may show information on the employee and a real-time video feed of the on-going emergency event as it captured by the employee's smartphone. The right screen may show the employee's current location on a map, and additional information that may be relevant for managing the on-going emergency event. In the illustrated example of a fire that broke out in one of the storage facilities, the additional information may include the identity of the product stored in that facility, the wind direction, the location of closest fire extinguishing means, and more.

In one embodiment, the suggested system provides a solution for increasing personal safety and process safety in an industrial environment. The solution is specifically beneficial when employees of external contractors are working in the industrial environment. When employees of external contractors work in a new place, there is challenge for preventing personal safety accidents and process safety accidents. The challenge is characterized in having a high exposure to a wide range of OSH risks, frequent turnover of contractor's workers (the works have now knowledge on hazards or ongoing tasks), legal responsibility (e.g., risks, qualified and authorized), difficulty to control (e.g., engagement of the external contractors' employees at the industrial environment is temporary by nature, and the employees are not under direct management of personnel belonging to that industrial environment), personal and professional norms may differ from the plant/company norms, built-in conflicts (e.g., throughput and speed of execution constitute a priority over safety), the fact that the external contractor has a number of jobs that are carried out simultaneously at different locations and consequently the contractor's employees are left in the field without supervision, training of the contractor's workers is rather limited, and the ability to ensure understanding and assimilation of the content, practically almost does not exist. Not less important, supervisors that belong to the plant/company receiving the external contractor's services, are unable to be provided with an appropriate information indicating the safety history of each of the contractor's employees.

The solution provided herein for the safety challenge of an external contractor's employees may include controlling and monitoring safety level associated with actions taken by the contractor, his employees, and the tasks that need to be carried out. In addition, the solution may include the ability to assess the external contractor's safety level while taking decisions on tenders and on provisioning of services by that external contractor.

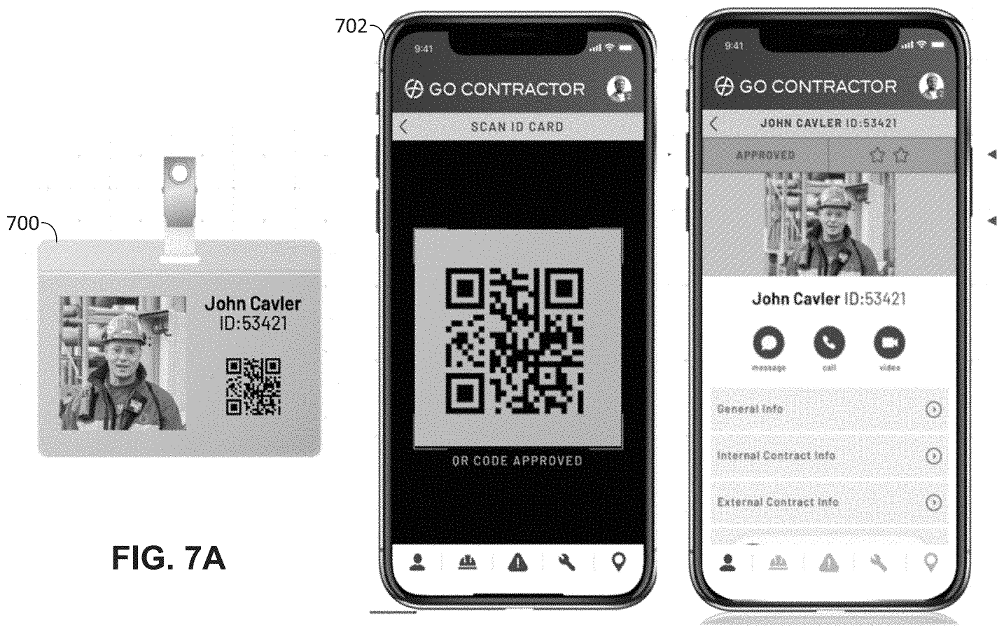

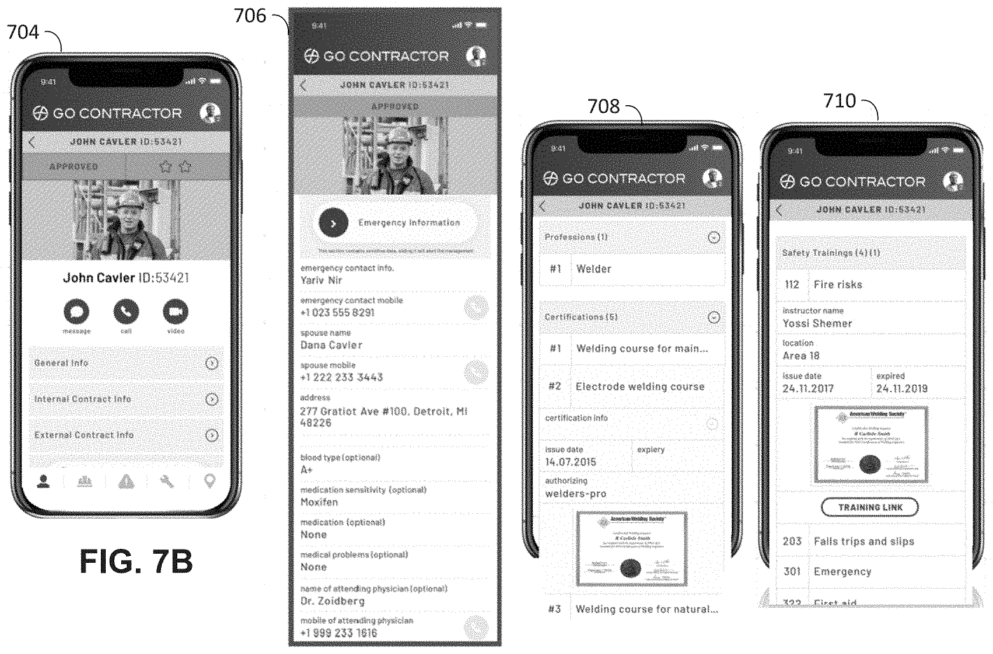

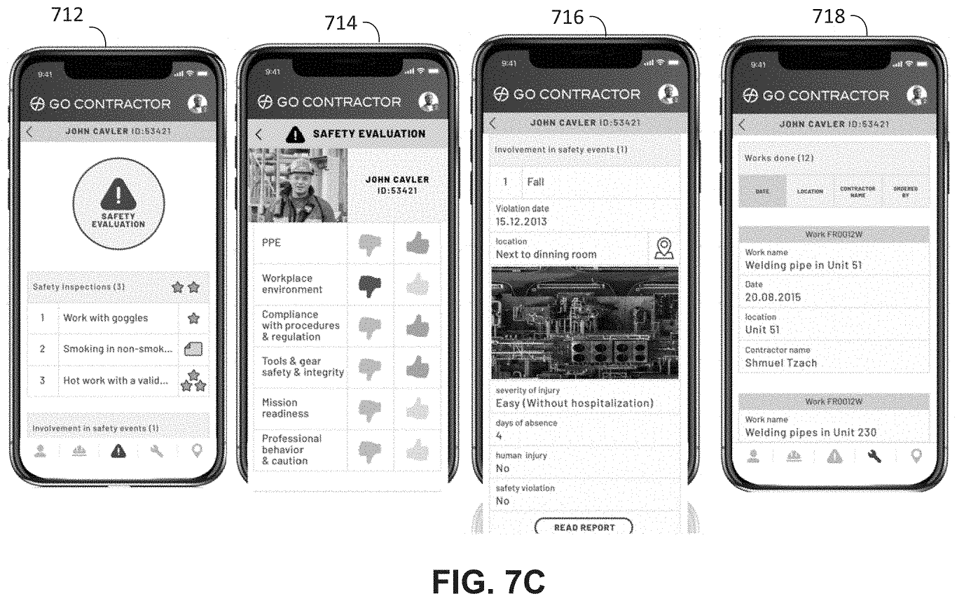

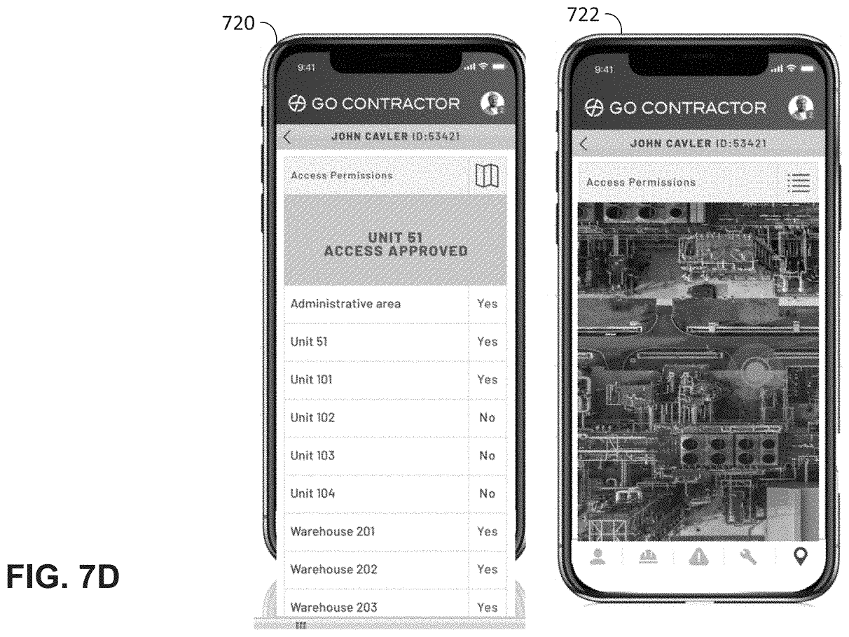

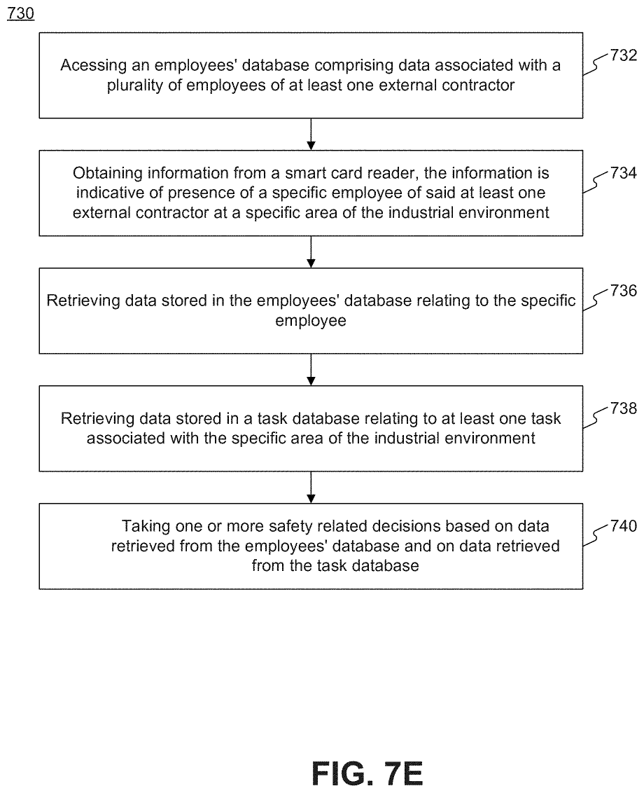

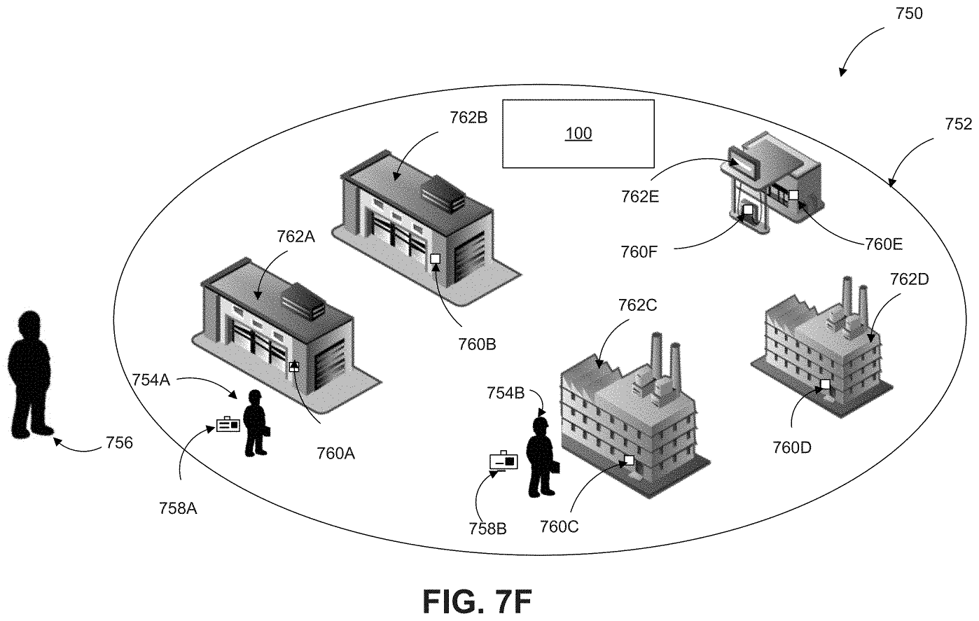

Reference is now made to FIG. 7F, which shows an example of a system 750 for managing safety measures for employees using smart cards. In one embodiment, system 750 may be used for reducing risks of work accidents in an industrial environment 752 caused by one or more employees 754 (e.g., employees 754A and 754B) of at least one external contractor 756. System 750 may include a plurality smart cards 758 (e.g., smart cards 758A and 758B). Each smart card 758 may be associated with a respective employee of said at least one external contractor. For example, smart card 758A may be associated with employee 754A and smart card 758B may be associated with employee 754B. System 750 may further include a plurality of smart card readers 760 (e.g., smart card readers 760A, 760B, 760C, 760D, 760E, and 760F). Each smart card reader 760 may be associated with a respective location 762 (e.g., buildings 762A, 762B, 762C, 762D, and 762E) of industrial environment 752. System 750 may include system 100 with network interface 206 configured to receive details of employees 754 of said at least one external contractor 756 that work or are scheduled to work in industrial environment 752. A memory device 234 configured to store data received at network interface 206 at at least one employees' database (e.g., database 120). At least one processing device 202 configured to: obtain information derived from a smart card reader (e.g., smart card reader 760C), the information is indicative of the presence of a specific employee (e.g., employee 754B) of external contractor 756 at a specific area (e.g., building 762C) of the industrial environment 752. The processing device may retrieve data stored in the employees' database 120 relating to the specific employee (e.g., employee 754B) and retrieve data stored in a task database (e.g., may also be part of database 120) relating to at least one task associated with the specific area of the industrial environment. For example, details about a task being executed or recently completed in building 762C. Thereafter, the processing device may take one or more safety related decisions based on data retrieved from the employees' database and on data retrieved from the task database. In one example, the one or more safety related decisions may be to provide employee 754B details on the task being executed or recently completed in building 762C. The details may be provided as a brief personalized to the specific employee based on the task associated with the specific area.

In accordance with another aspect, there is provided a method for reducing risks of work accidents in an industrial environment. The industrial environment may include one or more smart card readers associated with different locations of said industrial environment. The method may include providing plurality smart cards, each of at least some are associated with a respective employee of said at least one external contractor; providing an employees' database comprising data associated with a plurality of employees of the at least one external contractor; obtaining information from a smart card reader, the information is indicative of presence of a specific employee of said at least one external contractor at a specific area of the industrial environment; retrieving data stored in the employees' database relating to the specific employee; retrieving data stored in a task database relating to at least one task associated with the specific area of the industrial environment; and taking one or more safety related decisions based on data retrieved from the employees' database and on data retrieved from the task database.

Consistent with the present disclosure, a smart card, which may be provided for each contractor employee, may be linked to an on-line information system of contract workers. For example, a plant manager and supervisor may monitor the operation of one or more employees under real time conditions while being provided with all the important and updated data that relate to the external contractor's employee, and accordingly take safety decisions, thereby reducing the risks associated with the task being performed. In one embodiment, the smart card may be a member of a group that consists of a virtual card implemented in a communication device, (e.g., a smartphone) or a physical card with Near Field Communication (NFC) capabilities. FIG. 7A illustrates a process of scanning a smart card 700 by a card reader. In the illustrated example, the supervisor's smartphone 702 may function as the card reader to enable the supervisor to inspect the safety in the industrial environment. However, as one skilled in the art would recognize the card reader may be fixedly located in the entrance of a building or a room. In one embodiment, smart card 700 may be presented in a display of the contractor's employee's smartphone, similar to a virtual boarding pass. The contractor's employee may be required to scan his card every time he/she enters a different section of the industrial environment. In addition, the system may track the location of the employee by using readings retrieved from a GPS device associated with the smart card.

The plurality of smart cards assigned to the external contractor's employees and to the regular employees of the industrial environment may be linked to an on-line information system. The-line information system may be configured to store a virtual employee profile for each of the employees (e.g., the original employees and the employees of the at least one external contractor). The virtual employee profile may be stored in at least one employees' database, may include details pertaining to the employee of the contractor's personal emergency data (blood type, medication allergies, contact details, etc.), the employee's certifications, the employee's safety training, the employee's accident history, and the like. In one embodiment, the supervisor may receive from the contractor a link to virtual employee profile of a contractor's employee scheduled to arrive to the industrial environment. As illustrated in screenshot 704 in FIG. 7B, upon receiving the virtual employee profile, the supervisor may contact the contractor's employee. Screenshot 706 illustrates the employee's personal emergency data (e.g., blood type, allergies to medications, etc.). Screenshot 708 illustrates information about the employee's skills and information about the employee's certifications. Screenshot 710 illustrates information about the employee's safety training, information about the employee's past accidents' record, and the like.

According to another embodiment, system 100 may assess the external contractor's level of safety, based on information retrieved directly or indirectly from smart cards associated with all employees of the external contractor. FIG. 7C includes screenshots related to process of evaluating the performance of the employee and maintaining records of his/her involvement in safety events. The ranking of the employee and any safety-related data may be shared or be made available to other managers of related industrial environments. Specifically, the virtual employee profile may include details from safety inspections (e.g., screenshot 712), overall safety scores (e.g., screenshot 714), history details on involvement of safety events (e.g., screenshot 716) history of completed tasks in the industrial environment (e.g., screenshot 718). Consistent with the present disclosure, the system may take one or more safety related decisions based on data retrieved from the virtual employee profile. For example, prevent a certain employee of an external contractor from participating in a certain task.

According to another embodiment, the one or more safety related decisions may be taken based on real time and/or near real time data about at least one task that is currently taking place in a specific area of the industrial environment, a task is scheduled to take place in the specific area of the industrial environment, or a task that was recently completed in the specific area of the industrial environment. For example, a decision may be influenced by the fact that welding works are about to begin at the area in which a certain employee is currently working. In addition, the one or more safety related decisions may be taken based on data relating to at least one task that had already taken place in a specific area of the industrial environment. For example, there is a wet floor in the area where the employee is about to begin working.

Consistent with the present disclosure, system 100 may associate a risk score with a specific employee of the at least one external contractor who is present at the specific area of the industrial environment. Associating the risk score with the specific employee may include determining the risk score based on retrieved data or obtained risk score from a database. The determination that the specific employee is located at the specific area is based on information from the card reader. And the association of the risk score with the specific employee who is currently present at the specific area of the industrial environment, is based on data retrieved from the employees' database and on data retrieved from the task database. The risk score with a specific employee may affect the one or more safety related decisions about scheduled tasks and current tasks in the industrial environment. An example a way to implement the above embodiment may include the following steps: comparing the risk score associated with the specific employee who is currently present at the specific area of the industrial environment to a pre-defined threshold; initiating a safety related action when the risk score is greater than the pre-defined threshold; and forgoing initiating safety related action when the risk score is less than the pre-defined threshold.

In addition or in the alternative, a risk score may be determined for the at least one task when the latter is associated with a specific area of the industrial environment. The determination of the risk score for the task may be affected by the identities of employees located at the specific area, which are determined based on information from one or more card readers. For example, based on information from more than two cards readers. Accordingly, system 100 may update the risk score for the at least one task associated with the specific area of the industrial environment, based on data retrieved from the employees' database and on data retrieved from the task database. One example a way to implement the above embodiment may include the following steps: comparing the updated risk score for the at least one task associated with the specific area of the industrial environment to a pre-defined threshold; initiating a safety related action when the risk score is greater than the pre-defined threshold; and forgoing initiating safety related action when the risk score is less than the pre-defined threshold.

Consistent with other embodiments of the present disclosure, the smart card of the employee may be used by system 100 to ensure that only approved workers of the contractor may enter the plant, to ensure that the contractor's employees are present only at places and during times authorized to the contractor in the industrial environment, to ensure that a contractor worker only carries out a task to which he is authorized, qualified and supervised (including validation of authorizations and authority), to monitor contractor employees who pose a safety risk to the industrial environment, to monitor the contractor employees real-time locations for the purpose of safely evacuating them from dangerous areas in case of an emergency situation, to provide optimal treatment for a contractor worker requiring a treatment, to control the personal protective equipment of the contractor's employee in accordance with the risks associated with the task that requires the use of that equipment, and to monitor the employee's/contractor's professional experience in the plant and its historical activity.

Specifically, system 100 may monitor at least some (e.g., all) entrances and exits of all employees working in the industrial environment (e.g., the employees of the at least one external contractor). Moreover, the system 100 may determine, based on retrieved data, whether a certain employee is authorized to access a pre-defined location within the industrial environment, or whether a certain employee remains at the specific area of the industrial environment for more than a pre-define period of time. For example, FIG. 7D illustrates screenshots related to process of managing the access permissions of the employee. In one embodiment, the system of the industrial environment can determine or select which section of the industrial environment can the employee be granted/prevented access based on real-time conditions. The real-time conditions may be determined based on information about tasks associated with the specific location. Screenshot 720 provides a list of pre-defined locations and indications whether employee John Cavler is permitted to access them. Screenshot 722 provides a map view of the pre-defined locations. In one example (not shown) locations that employee John Cavler has access to may be marked in green and locations that employee John Cavler has no permit to access may be marked in red. The list of the pre-defined locations may be updated in real-time based on information of tasks being executed in said locations. For example, if a task is finished earlier than plan a certain location may be marked in green for the specific employee.

FIG. 7E is a flowchart of an example method 730 for reducing risks from integrating external contractor's employees in the industrial environment. Method 730 may improve the personal safety and the process safety in the industrial environment. Consistent with the present disclosure, method 730 may be executed by a processing device of system 100. The processing device of system 100 may include a processor within a mobile communications device (e.g., supervisor's handheld communication device 105C) or a processor within a server (e.g., server 115) located remotely from the mobile communications device. Consistent with disclosed embodiments, a non-transitory computer-readable storage media is also provided. The non-transitory computer-readable storage media may store program instructions that when executed by a processing device of the disclosed system cause the processing device to perform method 730, as described herein. For purposes of illustration, in the following description reference is made to certain components of system 100. It will be appreciated, however, that other implementations are possible and that any combination of components or devices may be utilized to implement the exemplary method. It will also be readily appreciated that the illustrated method can be altered to modify the order of steps, delete steps, or further include additional steps.

A disclosed embodiment may include accessing an employees' database comprising data associated with a plurality of employees of a at least one external contractor. The employees' database may be included in database 120. According to step 732, the processing device may access an employees' database comprising data associated with a plurality of employees of at least one external contractor. For example, the employees' database may include personal emergency data (blood type, allergies to medications, etc.), information about the employee's skills and information about the employee's certifications, information about the employee's safety training, information about the employee's past accidents' record, and the like.

The disclosed embodiment may further include obtaining information from a smart card reader, the information is indicative of presence of a specific employee of said at least one external contractor at a specific area of the industrial environment. A smart card reader may be any device that can be used to obtain information from an object used to identify the specific employee when the card reader is in the general vicinity of the object, such as an optical scanner, a near field communications device, a Bluetooth communications device, etc. According to step 734, the processing device may obtain information from a smart card reader, the information is indicative of presence of a specific employee of said at least one external contractor at a specific area of the industrial environment. For example, the obtained data may include a smart reader identifier (e.g., ID number, location name), an employee identifier (e.g., ID number, employee number), a link to a virtual employee profile, a time stamp, a previous location, details on the external contractor, etc.

A disclosed embodiment may include retrieving data stored in the employees' database relating to the specific employee. As mentioned above, the data may be retrieved by database access module 310 based on the obtained data from the smart reader. According to step 736, the processing device may retrieve data stored in the employees' database relating to the specific employee. The retrieved data may include any information associated with the specific employee from database 120. In one example, the retrieved data may include job professional, such as, welder.

A disclosed embodiment may include retrieving data stored in a task database relating to at least one task associated with the specific area of the industrial environment. This data may be retrieved by database access module 310 from database 120. According to step 738, the processing device may retrieve data stored in a task database relating to at least one task associated with the specific area of the industrial environment. For example, the retrieved data relating to the at least one task may include safety-related information such as: work procedures associated with the at least one task, information associated with an employee assigned to the at least one task, information associated with one or more locations of the at least one task, information associated with the at least one task, information associated with tools expected to be used in the at least one task, information associated with materials expected to be used in the at least one task, information associated with a time of the at least one task, information about calendar events, information associated with a weather expected to be during the at least one task, information from periodic inspection tours, and/or information associated with the industrial environment. Additionally, the retrieved data relating to at least one task may include the real-time information, such as, detected changes in performances of an employee assigned to the at least one task, detected changes in planned locations of the at least one task, detected changes in tools expected to be used in the at least one task, detected changes in materials expected to be used in the at least one task, detected changes in an expected start time of the at least one task, and detected changes in an expected weather during the at least one task.

A disclosed embodiment may include taking one or more safety related decisions based on data retrieved from the employees' database and on data retrieved from the task database. The one or more safety related decisions may be determined by accident prevention module 306. According to step 740, the processing device may take one or more safety related decisions based on data retrieved from the employees' database and on data retrieved from the task database. For example, the one or more safety related decisions may include updating a predicted risk score of a scheduled task, updating an actual risk score of a pending task, updating the employee virtual profile (e.g., safety evaluation) of the specific employee, and/or initiating a remedial action to prevent an accident associated with the specific area of the industrial environment.

The safety management system described in the present disclosure collects information from a wide variety of sources, processes the diverse information to generate a consolidated database in which safety-related information from different sources (employees, sensors, regulations, protocols, task schedules, work-permits, and so on) is stored in an interconnected fashion. This safety management system can process the consolidated database which is updated in real-time in order to provide different users relevant information which matches their current needs-making decisions, reporting safety hazards, granting and receiving permissions, receiving briefings and being debriefed, partake in safety-oriented learning groups, and so on.

Some of the main types of users of such safety management system are: employees deployed on the shop floor or on the field during performance of tasks; managers and supervisors on their ongoing supervisory tasks; safety controllers deployed on a control room or on the field, which need to respond to safety related events, to issue or withhold work permits in reaction to changing conditions on the shop floor; rescue teams and emergency response personnel when reacting to emergencies, and so on.

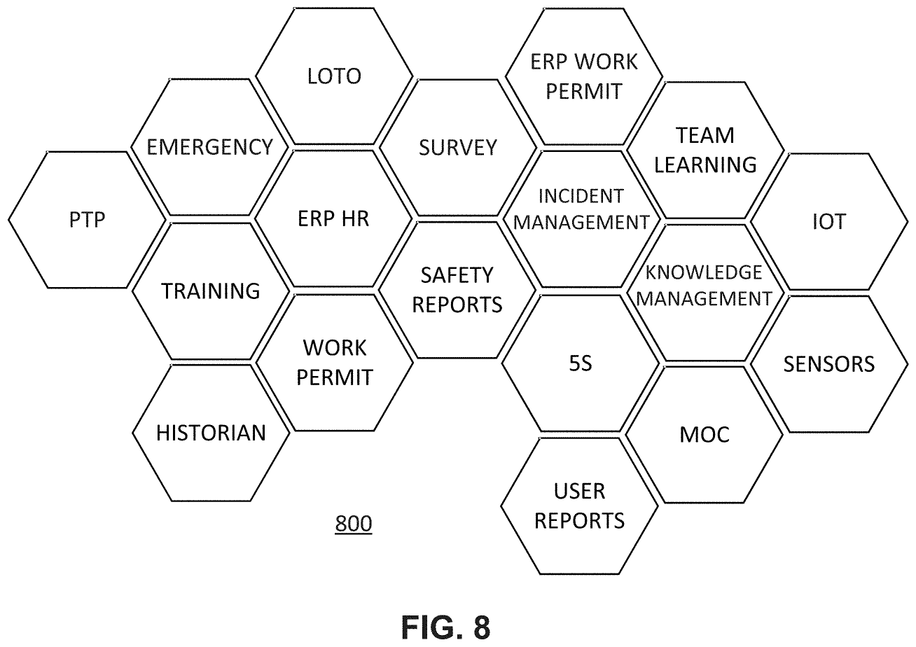

FIG. 8 illustrates a plurality of information sources, collectively denoted 800, available to a safety management system (e.g., system 100), in accordance with examples of the presently disclosed subject matter. It is noted that safety management systems according to the present disclosure may use only some of the disclosed sources of information. Safety management systems according to the present disclosure may also utilize other types of information sources 800 which are not mentioned in the example of FIG. 8, and possibly consolidate information from sources 800 with information from other sources. It is also noted the safety systems according to the present disclosure may also optionally update any one or more of such information sources 800 and databases (whether included in the example of FIG. 8 or not) in response to information from other sources available to the system and/or based on information generated by the safety management system itself. For example, human resources (HR) notification that an employee had to leave early for the day may be transmitted to an Enterprise Resource Planning (ERP) work permit, to verify if work permits granted to this employee should be withheld or replaced by work permits to other employees. It is noted that FIG. 8 includes several acronyms and other abbreviations which are of common use in the art (e.g., LOTO stands for “Log-Out Tag-Out”, and so on). Data sources 800 may be stored in one or more database 120, but this is not necessarily so.

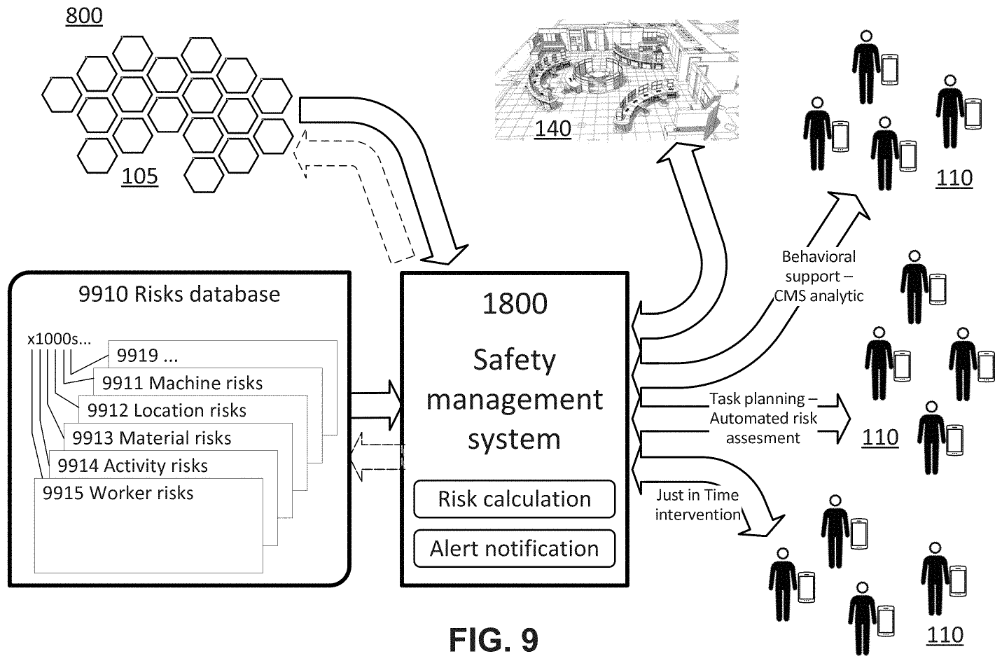

FIG. 9 illustrates interconnection of safety management system 100 with other modules, databases, and users, in accordance with examples of the presently disclosed subject matter. Risk database 9910 may include information of different types of risks (examples include machine risks 9911, location risks 9912, material risks 9913, activity risks 9914, worker risks 9915, and other types of risks, collectively denoted 9919). Risk database 910 may be part of safety management system 100, but this is not necessarily so. As can be seen, information may be passed from safety management system 100 to the different entities (e.g., users, sensors, databases) as well as in the opposite direction (e.g., including updates, instructions). It is noted that system 100 may implement any combination of any of the structures, capabilities, functions, modules, programming, and so on to implement the methods described herein.

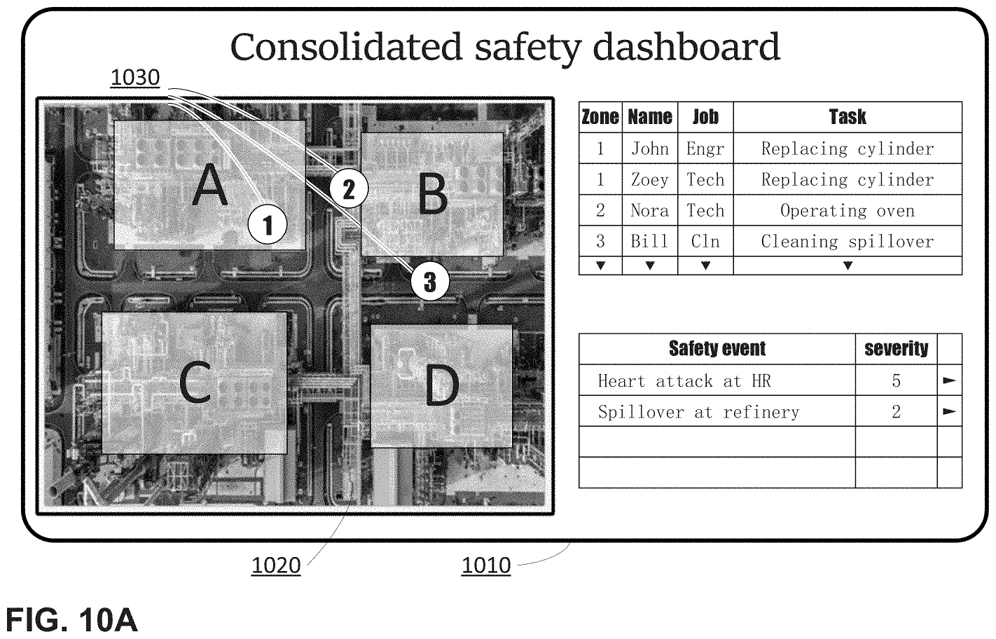

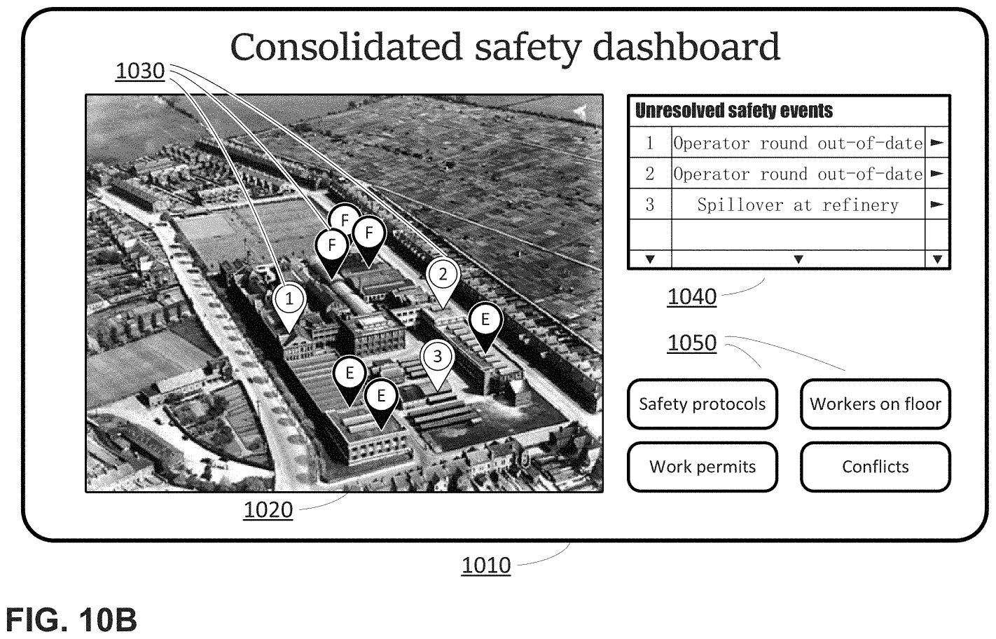

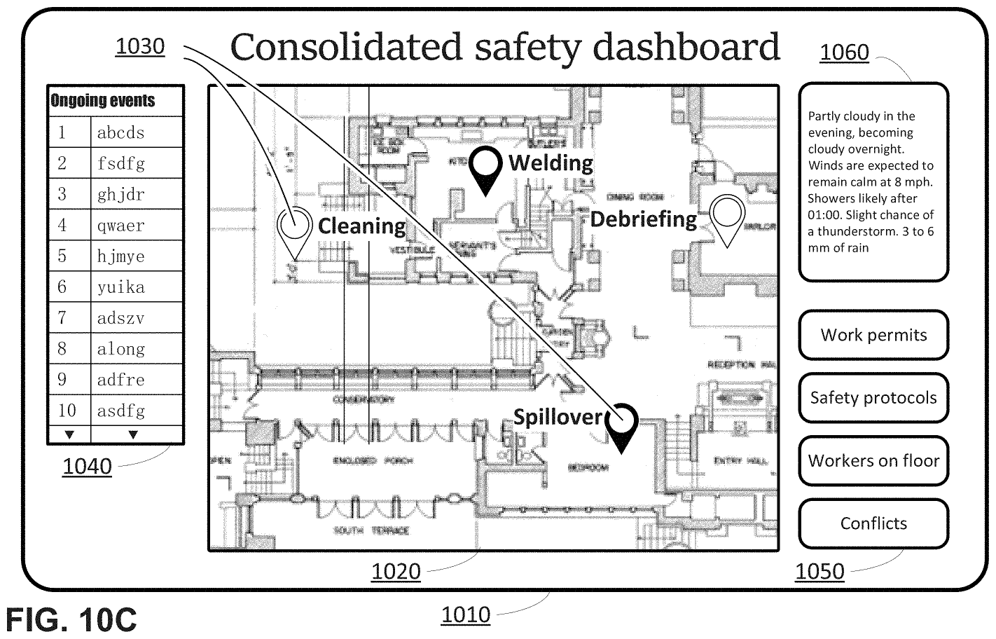

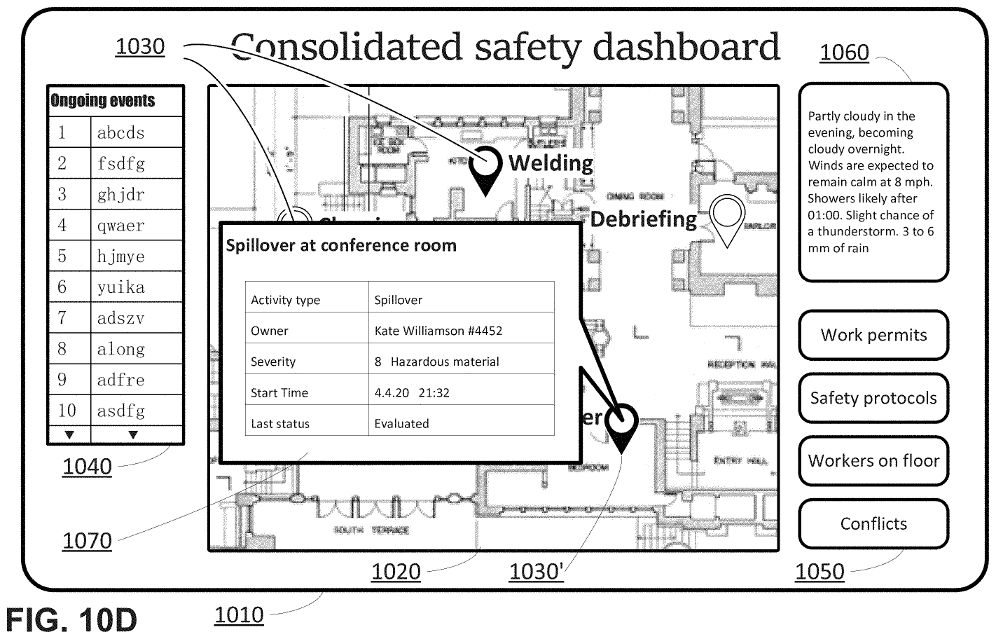

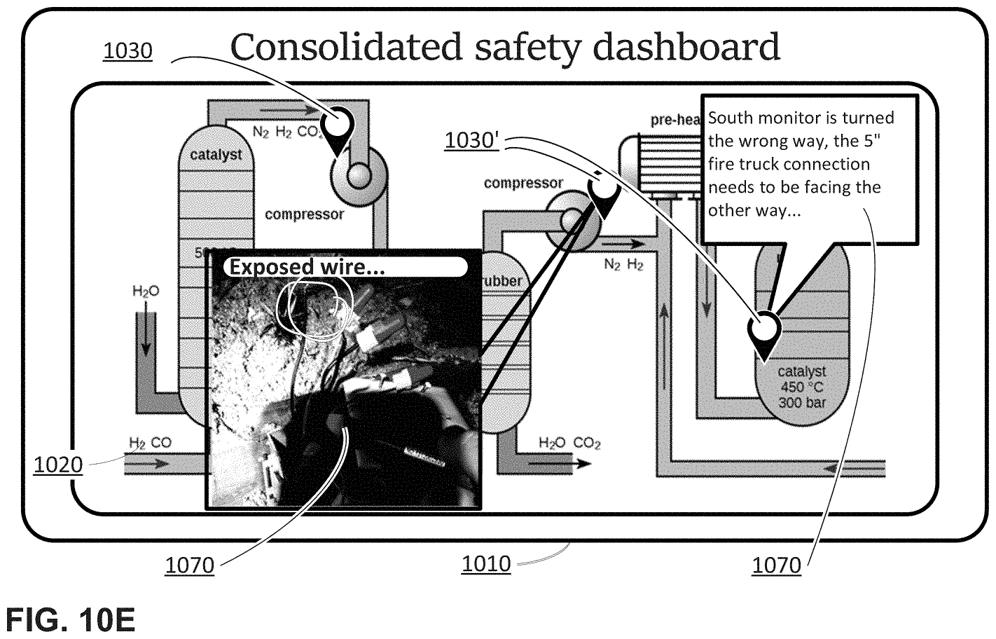

FIGS. 10A-10E illustrate graphic displays 1010 in accordance with examples of the presently disclosed subject matter. A safety management system as discussed in the present disclosure can optionally switch between several types of displays, each offering to one or more users different types of data at different types. The graphic displays 1010 in the examples of FIGS. 10A-10E include both graphical data and textual data, and present to the user amalgamation of data collected from different source on a single graphic map in order to improve the ability of the user to understand, manage and improve safety in the industrial environment. Clearly, a safety management system may have any different number of displays, which are not limited to the examples of FIGS. 10A-10E, or to combinations of location based graphic and textual displays.

The graphic display 1010 of FIG. 10A includes a map 1020 on which three specific-location indicators 1030 are identified. In addition, the graphic display includes two tabulated textual data 1040, the top one pertaining to the specific location indications 1030 (using similar reference numbers) while the second one includes titles of events which may be associated with location data, but not necessarily on the part of map 1020 which is currently displayed. Map 1020 of the example of FIG. 10A is an aerial photography photo with additional layers of data (e.g., buildings identifies “A” through “D”). The specific-location indicators 1030 may indicate locations of safety events, locations of fire hydrants, location of tasks which fulfil a certain criterion (e.g., which includes sub-contractors), or any other option provided by the safety management system, preferably as selected by a user of the system (such as a safety supervisor in a control room in which display 1010 is displayed).

The graphic display 1010 of FIG. 10B includes a map 1020 which is an unenhanced diagonal aerial photograph, and specific-location indicators 1030 of two types (one represented by a dark symbol on the display and the other represented by a bright symbol). The two types of indicators 1030 may be used to represent different types of localized data available to the system (e.g., current safety hazards and potential future safety hazards). The graphic display of FIG. 10B further exemplifies additional user interface 1050 selectable by the user, to request provisioning by the safety management system of additional data (including organizational data, safety data, and so on).

The graphic display 1010 of FIG. 10C includes a map 1020 which is an architectural floor plan. The specific-locations indicators 1030 in this example also include a textual description (e.g., type of task). Graphic display 1010 may also include longer textual descriptions 1060 (e.g., weather report, safety report, chat with workers, and so on).

The graphic display 1010 of FIG. 10D is the same graphic display of FIG. 10C but including an expansion pop-up 1070 which includes additional data provided by the safety management system with respect to a specific-location indicator 1030 selected by the user (denoted 1030′ in the example).

The graphic display 1010 of FIG. 10E includes a map 1020 which is a functional diagram of the manufacturing process. The expansion pop-ups 1070 in the illustrated example includes reports (one is textual and the other is a captured photo with employee's drawing on it) uploaded by employees reporting safety hazards on the shop floor.

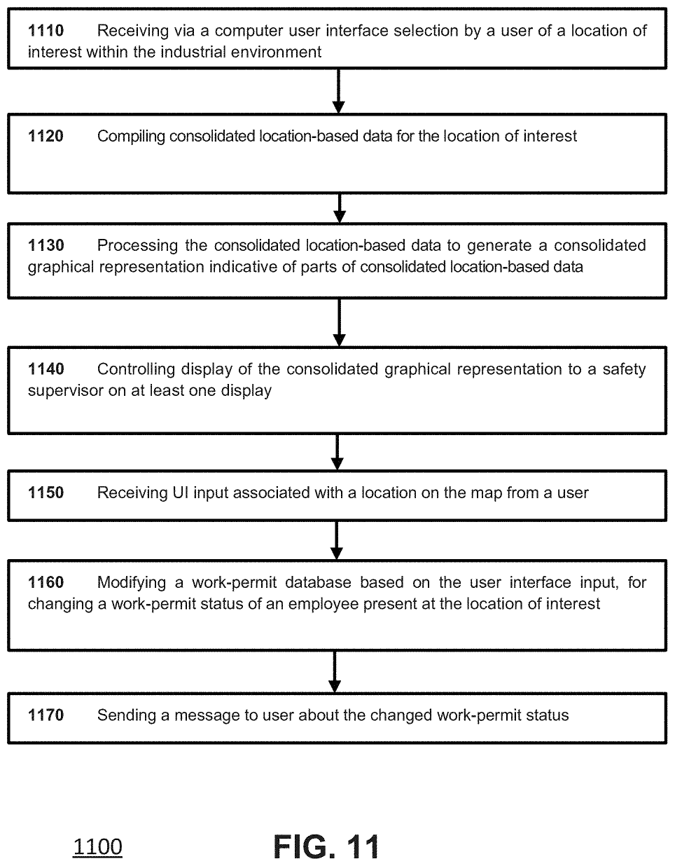

FIG. 11 illustrates method 1100 for real-time location-based safety management within an industrial environment, in accordance with examples of the presently disclosed subject matter. Referring to the examples set forth in the drawings, method 1100 and its different steps may be implemented by system 100.

Step 1110 includes receiving via a computer user interface selection by a user of a location of interest (LoI) within the industrial environment. For example, the user interface may be part of a control room 140, of a handheld communication device 105c, of an output unit 125, and so on. The UI may be displaying a map or other representation—graphical or textual—of various locations in the industrial environment, from which the user may choose, but this is not necessarily so. The user may be a manager, a safety supervisor, an Environment, Health, and Safety (EHS) team member, or any other person.

Step 1110 is followed by step 1120 of compiling consolidated location-based data pertaining to the location of interest, the consolidated location-based data including: safety-related information of multiple types for each out of a plurality of tasks whose execution affects safety at location of interest at the day of compiling; work permits for a plurality of people permitting work at the location of interest at the day of compiling; sensor information from a plurality of sensors in the location of interest obtained from at least three different types of sensors selected from a group consisting of: (a) a plurality of cameras located in the industrial environment, (b) a plurality of communication devices of employees in the industrial environment, (c) wearable sensors of employees in the industrial environment, (d) operational technology sensors, (e) environmental sensors, and (f) sensors associated with working tools. The sensor information may include, for example, data of operator rounds, machine information, data indicative of the state of execution of one or more tasks, and so on.

It is noted that the plurality of tasks may include any combination of: one or more concluded tasks (whose execution may still affect safety at the location of interest; also referred to as “past tasks”), one or more on-going tasks (whose execution began but have not yet concluded, also referred to as “present tasks”), and/or one or more planned tasks (the safety and permissibility of execution depends on past, present and possibly other planned tasks in the LoI, also referred to as “future tasks”). The plurality of tasks may include a plurality of present tasks and a plurality of future tasks—the safety of all of which should be managed. Such management may occur from a control room (among other options), and may include managing work-permits, tasks scheduling, task personnel assignment, and so on. Step 1120 is usually an ongoing stage, as new information is keep being received throughout the execution of method 1100—also in parallel to other steps of the method.

It is noted that step 1120 may also include compiling consolidated data which includes both location-based data (data associated with one or more locations, especially in the industrial environment) and non-location-based data. Such consolidated data structure may be used in all of the following steps where consolidated location-based data is referenced, mutatis mutandis. The term “consolidated location-based data” may pertain in some embodiments to consolidation of data which is entirely location-based, and in other embodiments to a combination of location-based data and non-location-based data.

Step 1130 includes processing the consolidated location-based data to generate a consolidated graphical representation indicative of selected parts of the consolidated location-based data. The consolidated graphical representation changes from time to time, based upon the content of data to be presented, on the needs and requests of the users, on events on the field, and so on. During at least some moments, the consolidated graphical representation generated in step 1130 may include representation of a map showing at least the location of interest; a graphical representation on the map of locations within the map area of a plurality of objects selected out of at least two of a set of object types consisting of: (a) people, (b) safety events, (c) safety reports, (d) location associated with a detailed report; (e) location associated with execution of a specific task; (f) location of a work-permit; and textual representation of a plurality of objects selected out of at least one type out of the object types. It is noted that step 1130 may also include selecting which data to include in the consolidated graphical representation. Such selection (and possibly also—processing to prepare for presentation, optionally including further data analysis) may be based on various factors such as (but not limited to): relevancy of considered data items to safety, interrelations between different bits of data, urgency, mode of use of the system (e.g., general review, work-permits meeting, responding to an emergency), and so on.

Step 1140 includes controlling display of the consolidated graphical representation to a safety supervisor on at least one display. This may include, for example, controlling display (e.g., by sending video content, by sending update data) to one or more computers or monitors at control room 140. Examples of optional consolidated graphical representation are provided in FIGS. 10A-10E.

Step 1150 includes receiving a user interface input of the safety supervisor associated with a location on the map. The input may be received from a computer at control room 140, from a handheld communication device 105c, or from any other user interface. Optionally, the user interface from which the input is received is the same user interface on which the consolidated graphical representation is displayed (e.g., touching a location on a map displayed on a touchscreen), but this is not necessarily so. Optionally, the user interface from which the input is received is associated with the user interface on which the consolidated graphical representation is displayed (e.g., a voice command received via a microphone connected to the same computer as the display of step 1140), but this is not necessarily so.

Step 1160 includes modifying a work-permit database based on the user interface input, for changing a work-permit status of an employee present at the location of interest. Work-permits may be granted (e.g., granting access of a welder to an evacuated room), withheld (e.g., preventing access of a previously permitted electrician to a room, because specific machine is still running), prolonged, shortened, suspended, and so on. Work-permits may be associated with a single person or with a group of people. Work-permits may be tied to one or more specific tasks or be more general.

Step 1170 includes sending to a device of the employee a message which includes information of the changed work-permit status. Such message may be textual, graphical, audial, etc. Referring to the examples set forth in the other drawings, the device may be handheld communication device 105c, output unit 125, and so forth.

Consistent with the present disclosure, safety management system 100 may be designed such that users can ask for more detailed data from the consolidated location-based data to address different needs. The request may be made using any user interface, e.g., the user interface of step 1150. Referring to the example of FIG. 10D, the graphical interface shows additional data which was requested by a user based on the graphical information provided at the example of FIG. 10C (e.g., by selecting the location pin marker). FIG. 10E provides another example for such additional details, provided over a map which uses functional diagrams instead of geographic or architectural plan.

Referring to method 1100 as a whole, it is noted that the ability to have safety-related data from varied sources consolidated on a single graphical interface (e.g., a map) allows user great control of many aspects of safety which needs to be handled in real time, such as work-permits management, controlling operator rounds, safety management meetings, responding to safety events, and so on. In addition, it is noted that method 1100 may be executed on the same system which implements any one or more of the other methods discussed in the present disclosure. It is therefore noted that any combination of one or more steps from any one or more of the other methods may be added to method 1100, mutatis mutandis.

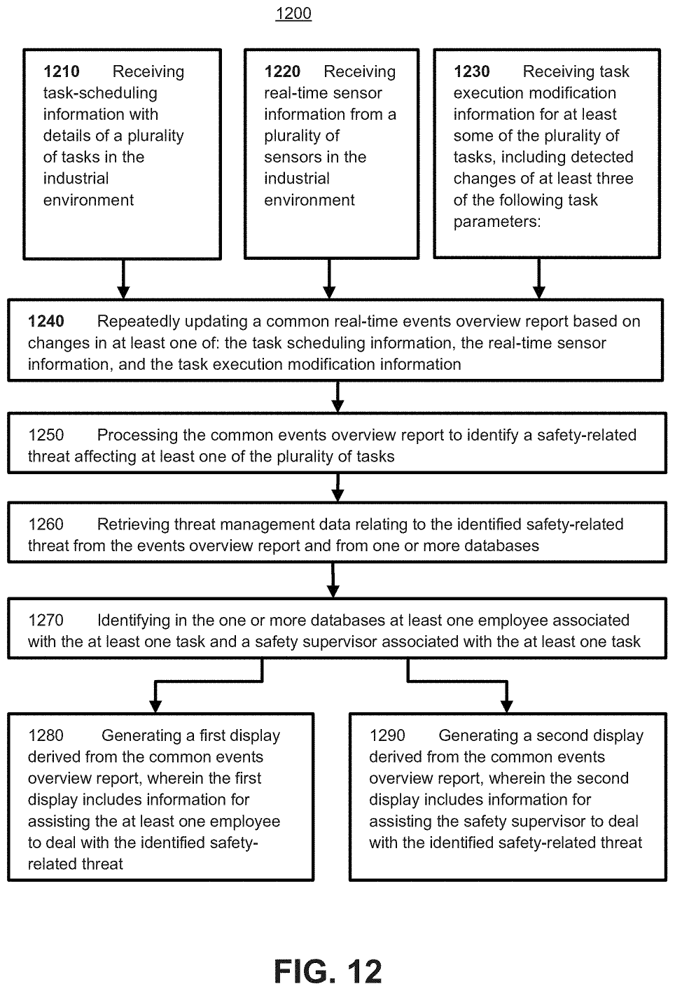

FIG. 12 illustrates method 1200 for providing real-time safety information at a plurality of locations within an industrial environment, in accordance with examples of the presently disclosed subject matter. Method 1200 may be used, for example, to present different subsets of the data collected by a safety management system (e.g., system 100) to different users based on their different needs. For example, in some cases, people in the shop floor may need immediate data or general instructions. Similarly, in other cases, people in a control room may need to plan a factory-wide response to an event or to reassign work permits.

Step 1210 includes receiving from a memory device (e.g., database 120, memory module of system 100) task scheduling information that includes details of a plurality of tasks associated with the industrial environment. Usually many such tasks would take place within the industrial environment (e.g., on shop floor, on the yard, on the offices). However, some tasks associated with the industrial environment may take place wholly or partly outside it. For example, such tasks may include deliveries, bringing up a booth in a convention, and so on. The plurality of tasks for which information is received includes at least multiple ongoing tasks (which are currently being executed, also referred to as “present tasks”) and multiple future tasks (which are scheduled to be executed at a later time, also referred to as “expected tasks” and “planned tasks”). The plurality of tasks may also include one or more concluded tasks (also referred to as “past tasks”), and even back-up tasks or other tasks for which there is no concrete plan to execute. Such tasks may be included, for example, in order to verify that they will be possible to execute should the need arise (e.g., making sure that an ambulance may enter the premises from at least one gate of the industrial environment).

Step 1220 includes receiving real-time sensor information from a plurality of sensors in the industrial environment. The real-time sensor information may be obtained from at least three (or at least four, or at least five) different types of sensors selected from a group consisting of: (a) a plurality of cameras located in the industrial environment, (b) a plurality of communication devices of employees in the industrial environment, (c) wearable sensors of employees in the industrial environment, (d) operational technology (OT) sensors, (e) environmental sensors, and (f) sensors associated with working tools.

Step 1230 includes receiving task-execution modification-information for at least some of the plurality of tasks. The modification information is any information which is indictive of changes which occurred, or which are planned or expected to occur in the execution of the task. Such information may be received from employees performing the task, from managers, from safety supervisors, from other people, from sensors, from ERP systems, from other data systems and databases, and so on. Some examples of task-execution modification information include one or more of: detected changes in performances of an employee assigned to the task; detected changes in planned locations of the task; detected changes in tools expected to be used in the task; detected changes in materials expected to be used in the task; detected changes in an expected start time of the task; detected changes in expected duration of the task; and detected changes in an expected weather during the task. In some implementations, step 1230 may include receiving modification information of two or more of the above identified types (a through f). In some implementations, step 1230 may include receiving modification information of three or more of the above identified types (a through f). In some implementations, step 1230 may include receiving modification information of four or more of the above identified types (a through f). In some implementations, step 1230 may include receiving modification information of five or more of the above identified types (a through f). While not necessarily so, steps 1210, 1220, and 1230 (or any one or two thereof) may be executed in an ongoing fashion, where incoming information is received in an ongoing fashion. The safety management system which executes method 1200 than operates to

Step 1240 includes repeatedly updating a common real-time events overview report based on changes in at least one of: the task scheduling information, the real-time sensor information, and the task execution modification information. The common real-time events overview report is also referred to as “consolidated real-time data” and “consolidated real-time events data”. The common real-time events overview report may be stored in one or more databases, or by any other database available to the safety management system executing method 1200 (e.g., system 100). The common real-time events overview report may include the consolidated location-based data discussed with respect to method 1100, but this is not necessarily so. The common real-time events overview report may include location-based data, and data which is not location-based. The term “common real-time events overview report” may be replaced with the term “situation report” which refers to a form of status reporting that provides decision-makers and readers a quick understanding of the current situation. It provides a clear, concise understanding of the situation-focusing on meaning or context, in addition to the facts.

Step 1250 includes processing the common events overview report to identify a safety-related threat affecting at least one of the plurality of tasks. The safety-related threat may optionally be a threat which is identifiable based (at least partly) on real-time data, which is collected during the execution of a task, and not available previously. For example, the data collected at the previous steps may indicate that a task which takes place at a lab will continue until 17:00 instead of 16:30. Since another task which is scheduled for 16:45 at the labs involves laser emission, there is an eye safety hazard for the employees performing the earlier task. Such a hazard may be resolved in several ways (e.g., postponing the second task, instructing employees of the earlier task to wear laser safety goggles, etc.) in the following steps.

Step 1260 includes retrieving threat management data relating to the identified safety-related threat from the events overview report and from one or more databases. For example, if the threat includes a potentially hazardous material, a protocol regarding the safety distance for unprotected personnel may be retrieved from the database.

Step 1270 includes identifying in the one or more databases at least one employee associated with the at least one task and a safety supervisor associated with the at least one task. Continuing the example of the laser lab, step 1270 may include identifying all of the people presently at the lab, and all of the employees scheduled to join for the 16:45 task. Step 1270 may also include identifying the lab supervisor of the specific lab, as well as a safety shift manager in the control room.

Step 1280 includes generating a first display derived from the common events overview report, wherein the first display includes information for assisting the at least one employee to deal with the identified safety-related threat. Step 1280 may also include controlling presenting of the first display on a handheld communication device 105c of the identified employee or on another computer or user interface available for presenting data to the employee. It is noted that step 1280 may also include presenting of audial data in addition to (or instead of) the graphic display. Examples for the first display are provided in FIG. 6B. Also, step 1280 may include updating and modifying the first display from time to time, e.g., based on new data, based on user selections or in order to convey more data which can be presented on a single display.

Step 1290 includes generating a second display derived from the common events overview report, wherein the second display includes information for assisting the safety supervisor to deal with the identified safety-related threat, wherein the second display differs from the first display. Step 1290 may also include controlling presenting of the second display on control room display (e.g., 1010) or on a handheld communication device 105c of the identified safety supervisor or on another computer or user interface available for presenting data to the safety supervisor. It is noted that step 1290 may also include presenting of audial data in addition to (or instead of) the graphic display. Examples for the second display are provided in FIG. 6C and FIGS. 10A-10E. Also, step 1290 may include updating and modifying the second display from time to time, e.g., based on new data, based on user selections or in order to convey more data which can be presented on a single display.

Method 1200 may be executed on the same system which implements any one or more of the other methods discussed in the present disclosure. It is therefore noted that any combination of one or more steps from any one or more of the other methods may be added to method 1200, mutatis mutandis.

Consistent with the systems and methods described above, it is noted that data collected from employees (as well as other data collected throughout method 1200) may be used for generating visual representation indicative of differences between the planning of tasks to what actually happened during execution. Nonvisual representation (e.g., an audio narrating such differences) may also be generated. Such representation may be presented to any employee in the industrial manager, either on a handheld communication device, on a fixed monitor (e.g., in a control room), or by any other suitable user interface (e.g., a speaker). Optionally, method 1200 may include generating a visual representation of the actual execution of a threatened task selected from the at least one task affected by the identified safety-related threat, relative to an expected execution of that threatened task (also referred to as “planned execution”). For example, information pertaining to the actual execution may be represented as a “blue line” or similar representation, while information pertaining to the expected execution may be represented as a “black line” or similar representation. Optionally, the visual representation of the actual execution of the threatened task may be generated based on the task execution information from the plurality of sensors in the industrial environment and the debriefing-responses of the first employee to the debriefing questionnaire. Method 1200 may include including the visual representation on the second display (at step 1290) and optionally controlling displaying of the second display to the safety supervisor on at least one monitor. It is noted that optionally, such information may be excluded from the one or more first displays provided to employees on the shop floor.

In disclosed embodiments, method 1200 may include generating different first displays to different employees, each including different risk-mitigating instructions selected for a respective recipient employee based on a role of the employee. Examples may include instructions for execution any of the risk mitigation actions provided above.

When generating the first display for one or more employees (whether such who are presently active in association with one of the tasks or such who are scheduled to engage with such a task in the future), details of the recipient employee may affect both the way data is displayed for the specific employee (e.g., display language, which data is shown first) and what data is selected to be shown. Such differences may reflect, for example, different risk mitigation actions and/or other remedial actions to be executed by the different employees. Relevant information about the one or more employees may include employee's history, qualification, present or future location, task, health, position in the organization, and so on. For example, method 1200 may include: retrieving from at least one database information pertaining to the different employees, including information pertaining to each of the employees which includes: safety-related historical data pertaining to the respective employee and information indicative of at least one of the respective employee's: health parameters, professional qualifications, and reviews; determining for each of the employees a new action for mitigating the safety-related threat based on the retrieved data associated with the respective employee, wherein different actions are determined for different employees; and generating for each of the different employees a respective first display derived from the common events overview report, which includes information of the new action determined for the respective employee.

In some embodiments, the safety-related threat may be associated with at least one of: (a) an ongoing task which is currently being executed, and (b) a future task which is scheduled to be executed at a later time. Optionally, method 1200 may include generating a first display for a first employee associated with an ongoing task, and generate another display based on the common events overview report for a second employee associated with a future task. For example, the first display of the common events overview report is based on a current location of the at least one employee, and second display of the common events overview report is indifferent to a location of the safety supervisor. Location information pertaining to the employee may be received, for example, from at least one out of: location sensor integrated in a portable device carried by the first employee, location sensor integrated in a clothes or other gear worn by the employee, remote location sensor identifying a portable device carried by the first employee (such as an RFID tag), and at least one security camera, to include data which is excluded from the second partial data. Examples of location-based remedial actions are provided above.

In other embodiments, the first display of the common events overview report may be displayed on at least one mobile communications device of the at least one employee and the second display of the common events overview report may be displayed on a control-room computer. Method 1200 may include updating the second display of the common events overview report based on data collected from at least one mobile communications device on which the first display is displayed. Such data may be entered by the employee (e.g., text, video, taking a photo of a safety hazard), may be sensed by a sensor included in the mobile communication device (e.g., handheld communication device 105c), and so on.

Consistent with the present disclosure, method 1200 may include generating first data to be displayed to an employee associated with a future task in response to at least one location which is associated with the future task and with a present task associated with the safety-related threat and in response to at least one tool of the future task which is not used in the present task. The first data generated for the future employee may be different that first data generated for an employee currently engaged in a task. Optionally, method 1200 may include identifying in the one or more databases multiple employees which are associated with the at least one task and generating the second display to include a map on which locations of the multiple employees are represented graphically. The second display may also include additional information such as other tasks affected by the newly detected security risk. The second display including the map may be, for example, the consolidated graphical representation of method 1100, or part thereof. Such a second display may include information (e.g., the map) which is excluded from the first display.

In other embodiments, the at least one task may include an ongoing task which is scheduled for execution before and after a shift change in the industrial environment. In such handover event—and especially when there is a safety risk or ongoing safety event—it is critical that both the current employee assigned to the task and the employee replacing them on the shift change will be coordinated. Such coordination may be facilitated by presenting to each of them coordinated data, which is relevant to their part of the task, before and after the handover. Method 1200 may thus optionally include identifying a present employee which presently perform the ongoing task and a future employee which is assigned to replace the present employee and generating different first displays to the present employee and to the second employee. Method 1200 may also handle in similar fashion other handover events, such as the ones exemplified above, mutatis mutandis.

Method 1200 may also include handling of work-permits by the safety supervisor (e.g., in a control room) which affect the employees involved in the task and is communicated to them using their handheld communication device or another form of first display generated in step 1280. For example, step 1280 may include generating the second display with an included user interface for modifying work permission of the at least one employee. Method 1200 may further include in such case receiving indication from the safety supervisor indicative of changes to the work permission of the at least one employee and updating the first display to inform the at least one employee of the changes to the work permission.

Referring to method 1200 as a whole, it is noted that method 1200 may be executed on the same system which implements any one or more of the other methods discussed in the present disclosure. It is therefore noted that any combination of one or more steps from any one or more of the other methods may be added to method 1200, mutatis mutandis.

Consistent with the present disclosure, safety management system 100 may be operable to provide different real-time safety information at a plurality of locations within an industrial environment. Specifically, network interface 206 of system 100 may be configured to receive scheduling information that includes details of a plurality of tasks associated with the industrial environment, wherein the plurality of tasks includes multiple ongoing tasks which are currently being executed and multiple future tasks which are scheduled to be executed at a later time; receive real-time sensor information from a plurality of sensors in the industrial environment, wherein the real-time sensor information is obtained from at least three different types of sensors selected from a group consisting of: (a) a plurality of cameras located in the industrial environment, (b) a plurality of communication devices of employees in the industrial environment, (c) wearable sensors of employees in the industrial environment, (d) operational technology (OT) sensors, (e) environmental sensors, and (f) sensors associated with working tools; and receive task execution modification information for at least some of the plurality of tasks, including at least three of: (a) detected changes in performances of an employee assigned to the task, (b) detected changes in planned locations of the task, (c) detected changes in tools expected to be used in the task, (d) detected changes in materials expected to be used in the task, (e) detected changes in an expected start time of the task, (f) detected changes in expected duration of the task, and (g) detected changes in an expected weather during the task;

Memory device 234 of system 100 may store data associated with the industrial environment. Specifically, memory device 234 may store, update, modify and/or delete any type of information discussed above with respect to method 1200, as well as any software modules and other software instructions required for execution of any one or more of the steps. Especially, memory device 234 may be used to store the common real-time events overview report discussed with respect to method 1200, as well as any other required databases.

Processing device 202 of system 100 (which may optionally be implemented as a plurality of processors, interconnected or not) may be configured to execute any one or more steps (e.g., by reading the relevant instructions from a nonvolatile storage medium of memory device 234). Specifically, processing device 202 may be configured to: repeatedly update the common real-time events overview report based on changes in at least one of: the task scheduling information, the real-time sensor information, and the task execution modification information; process the common events overview report to identify a safety-related threat affecting at least one of the plurality of tasks; retrieve threat management data relating to the identified safety-related threat from the events overview report and from one or more databases; identify in the one or more databases at least one employee associated with the at least one task and a safety supervisor associated with the at least one task; generate a first display derived from the common events overview report, wherein the first display includes information for assisting the at least one employee to deal with the identified safety-related threat; and generate a second display derived from the common events overview report, wherein the second display includes information for assisting the safety supervisor to deal with the identified safety-related threat, wherein the second display differs from the first display.

Consistent with the present disclosure, processing device 202 may be configured to generate different first displays to different employees, each including different risk-mitigating instructions selected for a respective recipient employee based on a role of the employee. Specifically, processing device 202 may be configured to retrieve from at least one database information pertaining to the different employees, including information pertaining to each of the employees which includes: safety-related historical data pertaining to the respective employee and information indicative of at least one of the respective employee's: health parameters, professional qualifications, and reviews; determine for each of the employees a new action for mitigating the safety-related threat based on the retrieved data associated with the respective employee, wherein different actions are determined for different employees; and generate for each of the different employees a respective first display derived from the common events overview report, which includes information of the new action determined for the respective employee.

Optionally, the safety-related threat is associated with at least one of: (a) an ongoing task which is currently being executed, and (b) a future task which is scheduled to be executed at a later time. Processing device 202 may be configured to generate a first display for a first employee associated with an ongoing task, and to generate another display based on the common events overview report for a second employee associated with a future task. Alternatively, processing device 202 may be configured to generate the first display of the common events overview report based on a current location of the at least one employee, and to generate the second display of the common events overview report independently of a location of the safety supervisor.

In some embodiments, processing device 202 may be configured to control displaying of the first display of the common events overview report on at least one mobile communications device of the at least one employee, and to control the displaying of the second display of the common events overview report on a control-room computer. For example, processing device 202 may be processor is configured to update the second display of the common events overview report based on data collected from at least one mobile communications device on which the first display is displayed.

In other embodiments, processing device 202 may be configured to generate the first data to be displayed to an employee associated with a future task in response to at least one location which is associated with the future task and with a present task associated with the safety-related threat and in response to at least one tool of the future task which is not used in the present task. Processing device 202 may be configured to identify in the one or more databases multiple employees which are associated with the at least one task, and to generate the second display to include a map on which locations of the multiple employees are represented graphically. Consistent with the present disclosure, the at least one task may include an ongoing task which is scheduled for execution before and after a shift change. Processing device 202 in such case may optionally be configured to identify a present employee which presently perform the ongoing task and a future employee which is assigned to replace the present employee, and to generate different first displays to the present employee and to the second employee.

Additionally, processing device 202 may be configured to control displaying of the second display which includes a user interface for modifying work permission of the at least one employee, to receive indication from the safety supervisor indicative of changes to the work permission of the at least one employee, and to update the first display to inform the at least one employee of the changes to the work permission.

The high-performance organization (HPO) is a conceptual framework for organizations that leads to improved, sustainable organizational performance. The present disclosure suggests incorporating Human and Organizational Performance (HOP) principles in system 100 to support a Field Learning Team (which is a team of several employees which take place on the shop floor, or otherwise on the field dedicated to learning together about how tasks are performed, and how tasks can be performed efficiently while maintaining being safe). Specifically, a user interface (UI) tool is provided, to identify the gaps between the “blue line” and the “black line”, according to the HOP principle described in “The Impact of Human Resource Management on Organizational Performance: Progress and Prospects” by Becker at el., which is incorporated herein in its entirety by reference. The UI tool may also identify possible errors, dangerous latent conditions, and weak defenses. System 100 may use machine learning algorithms to analyze the data and to provide recommendations to minimize the gaps between the “blue line” and the “black line”, or to assist workers, management and/or safety supervisors to process the differences between the blue line and the black line (also referred to as the “performance gap”). Processing the differences between work as actually practiced and work as planned may facilitate better understanding of why work is done the way it is done, and thereby to facilitate improvements in the planning of future tasks. Processing the differences between work as actually practiced and work as planned may facilitate better understanding by workers of why the work is designed as planned, and batter knowledge of why certain deviation from the task as planned are safer while other deviations are outright risky. Using the tool, we can identify the gaps between the “blue line” and the “black line”, identify possible errors, dangerous latent conditions, and weak defenses. Different embodiments of the UI tool for managing the safety of industrial environment based on HOP principle are illustrated in various figures.

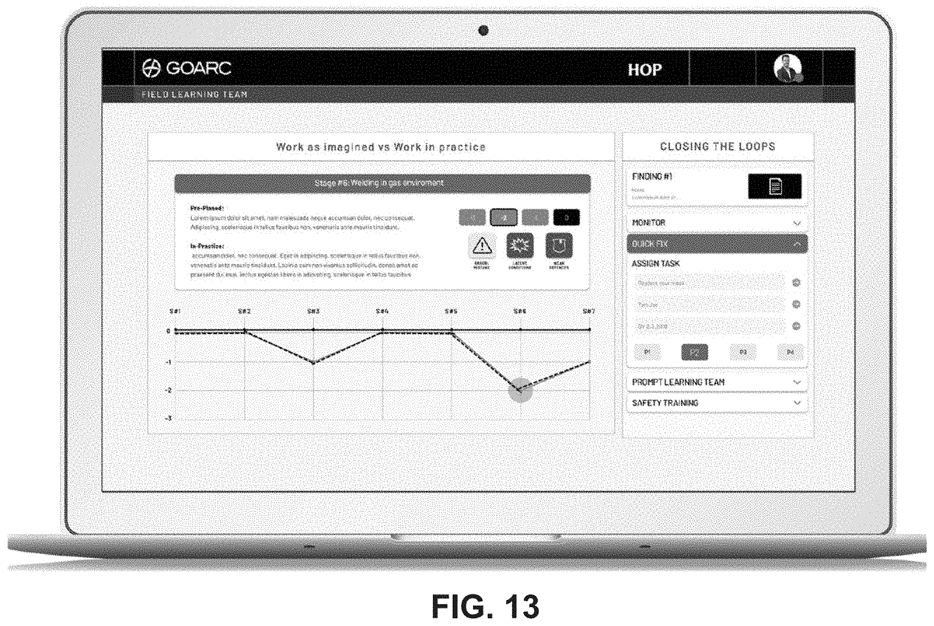

For example, FIG. 13 illustrates an example user interface showing the “blue line” and the “black line” according to the HOP principle described in “The Impact of Human Resource Management on Organizational Performance: Progress and Prospects” by Becker at el. Which is incorporated herein by reference in its entirety. The blue line is represented in a dashed line. The information illustrated in the user interface may be based on real data and actual event that occurred in the industrial environment. For example, the information may be obtained from workers of the industrial environment, in accordance with the presently disclosed embodiments. System 100 may use bots to communicate with the workers, a TTS (text to speech) generation unit to interpret recording of the worker, and image processing to identify what the worker captured in video stream. In some embodiments, system 100 may use speech synthesis algorithm to generate the speech data. Some non-limiting examples of such algorithms may include concatenation synthesis algorithms (such as unit selection synthesis algorithms, diphone synthesis algorithms, domain-specific synthesis algorithms, etc.), formant algorithms, articulatory algorithms, Hidden Markov Models algorithms, Sinewave synthesis algorithms, deep learning-based synthesis algorithms.

System 100 may utilize many different ways for improving safety in the industrial environment, for reducing risks and hazards and to assist employees, contractors, visitors, management and safety supervisors to overcome developing situations and other unforeseeable changes occurring during the operation of the industrial environment. As discussed throughout the present disclosure, system 100 may obtain data from a wide variety of sources, analyze this expansive data to identify security hazards (occurring or potential hazards), and to act in order to mitigate those risks (e.g., by taking an autonomous action such as changing operational parameters of machines in the industrial environment, by issuing alerts and alarms, by suggesting ways of operations to personnel, by modifying safety protocols). The data obtained by system 100 may include, for example, data collected by self-operating sensing devices 105 (i.e., devices which do not require human operation for collection of data; may be operated autonomously and/or according to instructions from server 115 or from another computer), such as cameras, machinery operation sensors, OT sensors, environmental sensors, smart work tools, wearable sensors (e.g., for sensing ambient, physiological, location, and/or other wearer-related information); data collected from people (e.g., employees, contractors, visitors, supervisors), such as textual data, drawings, audio, video, selection from multiple-choices, etc. Such data may be collected using a handheld communication device 105c, a computer, a workstation, machine UI, cameras and microphones in the workplace, and so on. Such data may include operator rounds data; data retrieved from databases and systems associated with the industrial environment, such as inventory, tasks scheduling, employees' data, work permits, safety protocols, Management Information Systems (MIS), Enterprise resource planning (ERP) systems, Transaction Processing Systems (TIS); and data received from external databases and systems, such as weather updates, pollution levels, activities outside the industrial environment (e.g., traffic updates, flight data, suppliers' inventory).

System 100 (e.g., one or more servers 115) may process the aforementioned data, which is continuously being updated—parts of the data being updated in real time while other parts are being updated less frequently (e.g., hourly, daily, weekly)—in order to create a unified model of what is happening in the industrial environment. System 100 (e.g., one or more servers 115) than analyzes the unified model (also referred to as “common real-time events overview” in order to detect safety risks (actual or potential) and in order to determine how to further act in order to mitigate the risk. It is noted that system 100 may further analyze the unified model in order to make other decisions which are not safety related (e.g., to identify that a task will probably take longer than expect, and to update other tasks in the industrial environment accordingly).

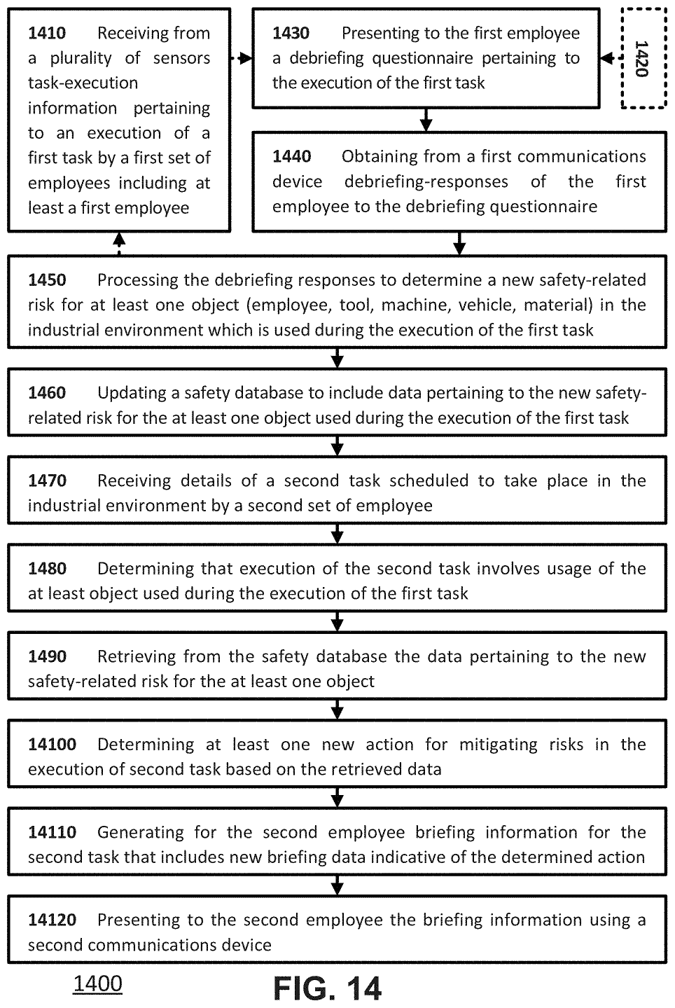

FIG. 14 illustrates method 1400 for adapting a safety management system to changing risks, in accordance with examples of the presently disclosed subject matter. Method 1400 may be executed by system 100 or by any system with similar architecture (even if the processing by server 115 is different than what is disclosed above). Method 1400 may be executed while various tasks are being executed in the industrial environment, which include preplanned tasks and possibly also newly decided upon tasks or even unplanned tasks (e.g., if a room is flooded, mitigation action may start before a formal task is entered into the system).

Planned tasks are usually preceded by briefing by system 100 of the one or more employees which are in charge of executing the task, and possibly also of other employees, visitors and contractor who may be affected by the task (e.g., who work in vicinity to the location of the task). The briefing may be carried out, for example, using a handheld communication device 105c, a computer terminal, a speaker, a microphone, a camera, or any combination of two or more of the above. The briefing may be an interactive briefing, in which the briefed person is required to answer question or otherwise provide data indicative of understanding of the briefing matter, especially of safety aspects of it (e.g., which actions are allowed or forbidden, what hazards may occur and how to mitigate them). The answers may be provided by text, voice, touch, or in any other way. It is noted that briefing may also occur during the execution of a task (e.g., if it's a very long task with several parts, if conditions of the tasks changed, if a new employee is joining an already occurring task), and in which case the methods, processes and systems relating to briefing may apply to mid-task briefing as well, mutatis mutandis.

The briefing may be prepared by system 100 (e.g., by server 115) or by another system for safety management in an industrial environment and is modified from time to time, so as to match for changing conditions. For example, the briefing presented for an employee which is about to take on a task may be modified based on different parameters such as: parameters of the employee (e.g., fixed parameters like qualifications or health, dynamic parameters such as time since start of present shift, previous or future tasks carried out in near future/past), parameters of other employees carrying out the task or a nearby task, weather data, inventory, state of other tasks in the industrial environment (e.g., planned or executed), and so on.

In addition to the briefing of employees prior to (or during) tasks, system 100 (or another safety management system) may also debrief some or all of the employees which took part in execution of the respective tasks, of managers, supervisors, etc. The debriefing is used to collect information which is not easily available in other means, relating to what went as planned in the task, which deviations from the original plans were, what were the reasons and implications of such deviations, what risk factors did the employee identify during the execution of the task, and so on. The debriefing may be carried out, for example, using a handheld communication device 105c, a computer terminal, a speaker, a microphone, a camera, or any combination of two or more of the above. The debriefing may be an interactive debriefing, in which the debriefed person is required to answer question or otherwise provide data indicative of understanding of the debriefing matter, especially of safety aspects of it (e.g., which actions are allowed or forbidden, what hazards may occur and how to mitigate them). The answers may be provided by text, voice, touch, or in any other way. It is noted that debriefing may also occur during the execution of a task (e.g., if it's a very long task with several parts, if conditions of the tasks changed, if a new employee is leaving an ongoing task), and in which case the methods, processes and systems relating to debriefing may apply to mid-task debriefing as well, mutatis mutandis. The debriefing may also include unstructured part, in which the employee is requested to provide their insights in natural language (e.g., writing, natural speak, video capture) or other free for (e.g., hand gestures, touching faulty machinery parts, etc.).

Method 1400 starts with step 1410 of receiving from a plurality of sensors in the industrial environment task-execution information pertaining to an execution of a first task in an industrial environment by a first set of employees. The first set of employees includes at least a first employee and is possibly a group of employees including other employees as well. The types of sensors from which task-execution information is received may be of any one or more of the types of sensors discussed above. referring to the examples set forth with respect to the previous drawings, step 1410 may be carried out by server 115, and the sensors from which information is received may be sensing devices 105. Step 1410 may be executed after the conclusion of the first task, during the execution of the first task, or both, and may even include data pertaining to the first task collected before the initiation of the first task.

As used herein, the term “Task-execution information” includes information which pertains to the task in its entirety, to any part or portion of the ask, or to any characteristic of the task (as defined above) or related to safety aspects pertaining to the execution of the task, even if pertaining to other tasks (e.g., what other tasks were executed concurrently to the respective task). The task related information may include safety-related information (as defined above), or to any other type of information collected by the system which executes method 1400 (e.g., system 100). The task related information may include real-time information (as defined above) or non-real-time information. For example, non-real-time information may be retrieved from database in response to task-execution information detected by sensors, in response to information provided by one or more of the first set of employees, and so on. For example, if an employee which was not supposed to be present at a location of the task is identified by a camera, health details of the employee may be retrieved from a non-real-time database. In another example, alerts from external sources that a certain material was leaked to the atmosphere may lead to retrieval of safety protocols related to the material from existing non real-time databases.

Optionally, some or all of the sensors of step 1410 may be included in a handheld communication device 105c or any other device carried by the first employee or another employee of the first set of employees, may be a wearable sensor connected to (or integrated with or in) a clothing worn by the first employee or another employee of the first set of employees. Referring to handheld communication devices 105C or other types of first computers, optionally the first computer may include a plurality of sensors for monitoring execution of the first task. In such case, the task execution information may include information collected by the sensors of the first computer. Parameters sensed by such sensors integrated into the first computer may include parameters relating to the employee itself (e.g., location, body temperature), to the environment of the employee (e.g., ambient temperature, atmospheric contents, light level), to the execution of the task (e.g., if the task involves using of the first computer, if the first computer can connect to machines or tools used or affected in the first task).

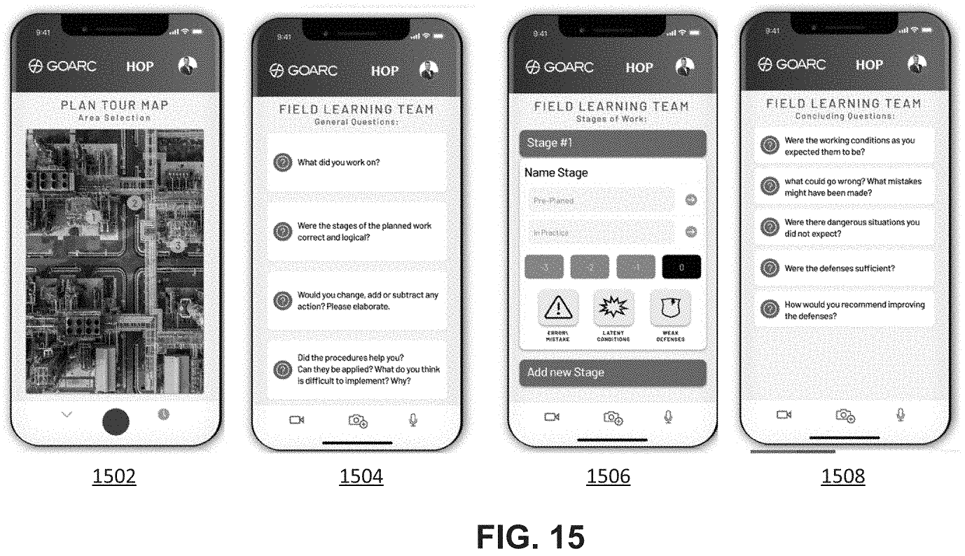

Step 1430 is executed following a completion of the first task and includes presenting to the first employee a debriefing questionnaire pertaining to the execution of the first task. Referring to the examples set forth with respect to the previous drawings, Step 1430 may be executed by server 1430, by handheld communication device 105c (based on information received from server 115 or from another computer). Optionally, step 1430 may be executed by any other computer in the industrial environment. The presenting of the debriefing questionnaire may include presenting of visual, audial, textual, or any other type of sensory data. The debriefing of step 1430 may include, for example, any debriefing variation discussed above. In some embodiments, the briefing towards a task may be prepared based on various factors, including the answers or inputs provided by employees with respect to previously executed tasks. The previous tasks may be of the same type of the present task (e.g., maintaining a specific piece of machinery) but may also pertain to tasks of other types. An example of the debriefing process is illustrated in FIG. 15 and the process of reporting a hazard by an employee of the industrial environment is illustrated in FIG. 6A. While the reporting of a hazard may occur as an integral part of executing a task, as a part of a supervisor round, or otherwise, a similar reporting may also be executed as part of the debriefing following a completion of a task. Sometimes, the debriefing itself may assist, facilitate and encourage the employee to identify and report safety-related risks (or data indicative of such risks) which was not reported in real-time, or was not deemed important by the employee without the instructions and encouragement of the debriefing.

Step 1440 includes obtaining from a first communications device debriefing-responses of the first employee to the debriefing questionnaire. The first communication device may be the same device which served the employee to provide their debriefing information (e.g., handheld communication device 105c), but this is not necessarily so. Referring to the examples set forth with respect to the previous drawings, step 1440 may be executed by server 115. Step 1440 may optionally be repeated to obtain debriefing-response of other employees, supervisors, and/or managers involved in the execution of the first task or of related (e.g., concurrent) tasks. Consistent with the present disclosure, all the activities which may be taken by the employee and/or by system 100 which are discussed with respect to FIGS. 15 and 6A may also be executed as part of the debriefing of steps 1430 and 1440.

It is noted that the debriefing of the first employee (as well as optionally other employees, supervisors, and managers involved in the execution of the first task) at steps 1430 and 1440 may be based on task-execution information gathered in step 1410 (as indicated by a respective dotted arrow). In some embodiments, step 1430 may be preceded by step 1420 discussed below. It is further noted that optionally the retrieval of task-execution information at step 1410 may be based on information provided by the employee during the debriefing (represented by a dotted arrow from step 1450 to step 1410).

Step 1450 includes processing the debriefing responses to determine a new safety-related risk for at least one object which is associated with the industrial environment and that was used during the execution of the first task. In different implementations, the object may include any combination of one or more of the following: at least one employee; at least one tool, at least one machine, at least one vehicle, at least one material. It is noted that step 1450 may be executed for a plurality of objects. Furthermore, the safety-related risks for one object may be determine based on processing of information pertaining to another object, and vice versa. The object may be associated with a lot of data pertaining to the object, such as: location, operational state, readiness, use history, inventory, and so on. Consistent with the present disclosure, step 1450 may optionally include determining the new (i.e., not previously identified) safety-related risk based on debriefing information obtained from of a plurality of people, optionally including other employees, supervisors, and managers involved in the execution of the first task or of related tasks. It is also noted that optionally, step 1450 may include determining the new safety-related risk based on the debriefing information and on additional information available to server 115 (or to whichever one or more computers executing step 1450). The additional information may include any information of the information types discussed above, for example. The determining of the new safety-related risk may include determining synergy data as described above, where part of the information used for the determining of the synergy data is the debriefing responses from the one or more employees. The determining of the new safety-related risk may include determining predicted risk score for a task or another object in the industrial environment, e.g., according to the processes described above with respect to determining predicted risk scores. Step 1450 may include determining the new safety-related risk based on processing of the debriefing responses of the first employee together with the task execution information received from the plurality of sensors in the industrial environment.

Step 1460 includes updating a safety database to include data pertaining to the new safety-related risk for the at least one object used during the execution of the first task. Referring to the examples set forth with respect to the previous drawings, step 1460 may be executed by server 115. Referring to the examples set forth with respect to the previous drawings, the safety database may be database 120. In some embodiments, the safety database may be updated with synergetic risk assessment data generated by assessing the task execution information in response to new information received from the first employee during the debriefing and determining the new safety-related risk based on the synergetic risk assessment data. For example, the synergetic risk data may pertain to resources of the factory and/or to how the specific task was executed.

Step 1470 includes receiving details of a second task scheduled to take place in the industrial environment by a second set of employees. The second set of employees includes at least a second employee and is possibly a group of employees including other employees as well. The task details may be received from a computer, from a database and/or from a user (e.g., manager, supervisor) using a dedicated user interface. Referring to the examples set forth with respect to the previous drawings, step 1470 may be executed by server 115. It is noted that while in the illustrated method step 1470 precedes steps 1480, 1490, and 14100, but this is not necessarily so. It is also noted that 1470 may follow steps 1410 through 1460, but this is not necessarily so. Notably, the reception of the details of the second task of step 1470 may be carried out at any time before 14100, and in some embodiments also at any time prior to step 14110. In one embodiment, the second task may be of the same or of a different type than the first task. The second task may optional require at least one tool not required for the execution of the first task. The details of the second task may include, for example, characteristics of the task the include at least one of: an estimated start time of the task, an identity of employees expected to participate in the task, an expected time duration of the task, potential accidents associated with the task, potential accidents associated with the identity of employees, types of materials expected to be used in the task, and types of tools expected to be used in the task. Specifically, the details of the second task may include, for example, one or more types of safety-related information which includes any combination of one or more of the following: work procedures associated with the task, information associated with an employee assigned to the scheduled task, information associated with a location of the scheduled task, information associated with the scheduled task, information associated with tools expected to be used in the scheduled task, information associated with materials expected to be used in the scheduled task, information associated with a time of the scheduled task, information about calendar events, information associated with a weather expected to be during the scheduled task, information from periodic inspection tours, and information associated with the industrial environment.

Step 1480 includes determining that execution of the second task involves usage of the at least object used during the execution of the first task. Referring to the examples set forth with respect to the previous drawings, step 1480 may be executed by server 115. It is noted that optionally, method 1400 may include determining that execution of the second task involves usage of at least one other object (different than the at least object used during the execution of the first task) which is nevertheless affected by the newly identified safety-related risk (of step 1450) and which therefore requires different protocol to operate. In such case, the following steps all refer to that at least one other object, mutatis mutandis. For example, the newly identified safety-related risk may have been identified with respect to the a similar machine (even though not the same one), to employees of similar characteristics (for example, asthmatic employees may be affected by leaked materials from different machines, which may be caused in extreme weather which occurred during the first task). The determining that the same object was used may be facilitated by the data associated with the object (e.g., location, operational state, readiness, use history, inventory, and so on).

Step 1490 includes retrieving from the safety database the data pertaining to the new safety-related risk for the at least one object. Referring to the examples set forth with respect to the previous drawings, step 1490 may be executed by server 115 and the database may be database 120. The retrieved data may be any type of data stored in the database.

Step 14100 includes determining at least one new action for mitigating risks in the execution of second task based on the retrieved data. It is noted that the at least one new action for risk mitigation may be determine further in response to additional data, e.g., to existing safety protocols, to existing operational protocols, to previous (or newly) determined synergy data (e.g., as described above), to previous (or newly) determined predicted risk score associated with the second task (e.g., as described above), and to any type of data available to server 115—from database 120, from other databases (e.g., external to the company), from sensors, from external update feeds, and so on. Referring to the examples set forth with respect to the previous drawings, step 14100 may be executed by server 115. It is noted that step 14100 may optionally (but not necessarily) involve human input as part of the determining of the at least one new action. Some types of new actions may be executed by computers or other machines, and do not require execution by employees. For example, operational parameters of some machines may be modified. In another example, new limits may be placed on operations or processes in the industrial environment. Such actions may be executed autonomously by server 115 (or another system which executes method 1400), or with the approval or other type of involvement of one or more people. The new actions may be active actions in the industrial environment (e.g., physically or digitally), and may also include actions such as modifying of safety protocol, of safety databases, etc. Additional possibilities and details regarding the actions which may be taken to mitigate this new safety-related risk are provided further below.

Step 14110 includes generating for the second employee briefing information for the second task that includes new briefing data indicative of the determined action. The briefing information newly generated for the second employee may be different than any briefing information presented by the system to any employee in the past. For example, the new briefing information may include new briefing data, may inform the employee of new steps or actions which were not required in the past, may include new questions to be presented to the employee (or new expected responses to prior questions, indicative of previously unrequired or untested understanding of the employee with respect to the new safety-related risk), and so forth. Referring to the examples set forth with respect to the previous drawings, step 14110 may be executed by server 115. Optionally, step 14110 may include executing by at least one processing device (e.g., processing device 202) software instructions which are included in any combination of one or more out of: task characterization module 300, pre-task planning module 302, by task supervision module 304, by accident prevention module 306, by process confirmation module 308, by database access module 310. Some examples of briefing information which may be created for the second employee may include: (a) personalized training based on real safety incidents included in the historical safety-related information; (b) recommendations on how to execute the task according to the work procedures; (c) information on existing hazards located in an area associated with the task; (d) information on potential hazards located in an area associated with the task; (e) real-time information (current or recent) which is obtained, for example, from at least one of: a plurality of cameras located in the industrial environment, one or more communication devices of employees in the industrial environment, wearable sensors of employees in the industrial environment, operational technology (OT) sensors, environmental sensors, and sensors associated with working tools.

The briefing information may be used for verifying understanding of the new safety-related risk and its possible outcomes by the second employee. Step 14110 may include generating the briefing information for the second employee that includes new questions relating to the new safety-related risk, and understanding-verification data (which may be presented to the second employee or simply serve for verification by system 100) for verifying that answers of the second employee reflect understanding of the new safety-related risk. The questions may be general (e.g., “where are you going to work today”, “what possible safety events may occur”, “what you can and should do to prevent them”) but may also be much more specific (e.g., “how will you prevent opening of latch A443 for causing injury to an operator of the drill?”).

In some instances, execution of the following task may start before the completion of an earlier task. However, if important information was discovered in the debriefing of the first task, method 1400 may include generating and presenting of the briefing information for the second employee after the start of the second task (e.g., as a real-time update), for mitigating safety-risks of the second task. It is noted that real-time updates-some of which are indicative of newly discovered safety-related hazards—may be provided by system 100 based on any new information available to server 115: from employees, from sensors, from databases, and so on.

Step 14110 is followed by step 14120 which includes presenting to the second employee the briefing information using a second communications device. Referring to the examples set forth with respect to the previous drawings, step 14120 may be executed by server 115, by handheld communication device 105c, by a UI of another one or more computer in the industrial environment, or by any combination thereof. It is noted that the briefing information may be presented in different ways, such as any combination of any one or more: textual data, visual data, voice instruction, other audial data, etc. The briefing instructions may be static or dynamic. In the latter case, the briefing instructions may be updated, for example, to follow execution of a complicated risk-mitigating action, when the actions are changed due to changing conditions, to inform of changing conditions, based on requests by the second employee, and so for. Optionally, the briefing instructions may include displaying the real-time hazard on a personalized map together with a visual indicator of the real-time hazard's severity.

It is noted that method 1400 may continue also after the initiation of the second task. For example, method 1400 may include monitoring execution of the second task based on data collected or generated in previous steps (e.g., as part of the debriefing of the first employee, as part of the identifying of the new safety-related risk). Optionally, the second computer may include a plurality of sensors for monitoring execution of the second task, and method 1400 may further include monitoring execution of the new action based on data collected by the sensors of the second computer.

As aforementioned, the presenting of the debriefing information of step 1430 may be preceded by optional step 1420, which includes generating the debriefing information. Referring to the examples set forth with respect to the previous drawings, step 1420 may be executed by server 115. The debriefing information may be generated based on processing of any combination of any one or more of the following: task-execution information collected from the sensors with respect to the first task; task-execution information obtained from sensors and/or from databases pertaining to other tasks (e.g., in the same or nearby location to the first task, utilizing the same or similar equipment to the first task, involving the same or similar employees); information pertaining to the first employee and/or to other employees involved in the planning, execution, or supervising over the first task or over related tasks (whether such employees are part of the first set of employees or not); safety protocols and other safety information (e.g., stored in database 120); any other types of data stored in database 120, generated by server 115, or available from external sources—e.g., as discussed above with respect to any of those options.

Method 1400 and to the processes executed by system 100 for generating new briefing information (e.g., as part of step 14100) and of generating new debriefing information (e.g., as part of step 1420), it is noted that the generating of new briefing material and/or new debriefing material (e.g., questionnaires, informative data, natural language processing) may be based on many different factors and not just (or only) on responses of employees pertaining to former activities and tasks. For example, new briefing information and/or new debriefing information may be generated by system 100 in response to any combination of one or more of the following: (a) safety hazards and other data voluntarily provided by users; (b) data provided by users in response to requests by the system (e.g., as part of the briefing or debriefing processes); (c) data detected by sensors; (d) changes to the planned tasks; (e) changes to safety protocols or other protocols; (f) statistical analysis of previous data, and so on.

Consistent with the systems and methods discussed above, and all variations thereof, it is noted that any data collected from employees (as well as other data collected throughout method 1400) according to the above systems, methods and examples may be used for generating visual representation indicative of differences between the planning of tasks to what actually happened during execution. Nonvisual representation (e.g., an audio narrating such differences) may also be generated. Such representation may be presented to any employee in the industrial manager, either on a handheld communication device, on a fixed monitor (e.g., in a control room), or by any other suitable user interface (e.g., a speaker). Optionally, method 1400 may include generating a visual representation of the actual execution of the first task relative to an expected execution of the first task (also referred to as “planned execution”). For example, information pertaining to the actual execution may be represented as a “blue line” or similar representation, while information pertaining to the expected execution may be represented as a “black line” or similar representation. Optionally, the visual representation of the actual execution of the first task may be generated based on the task execution information from the plurality of sensors in the industrial environment and the debriefing-responses of the first employee to the debriefing questionnaire.

As mentioned above in the discussion of step 14100, different actions may be determined to be useful for mitigating the new safety-related risk. Optionally, the new action (or actions) determined in step 14100 may include any combination of any one or more of the following: a risk-mitigating action to be executed by the second employee (possibly as part of a group of people). In such case, the generating of the briefing information for the second employee as step 14110 may comprise including in the briefing information new instructions for execution of the risk-mitigating action by the second employee. Optionally, the second computer or other sensors may be used to verify execution of the new action; a risk-mitigating action to be executed by one or employee other than the second employee. In such case the employee may be informed of the action, may be requested to evacuate, or to wait until the risk-mitigating action is concluded before resuming work; a risk-mitigating action to be executed by an automated machine in the industrial environment. Few examples include a production-related machine; a work-place safety machine (e.g., sprinklers); a tool (e.g., a smart tool); a computer; a sensor, a handheld device.

As mentioned above, the one or more determined risk-mitigating actions may involve different combination of one or more employees, machines, computers, etc. Some examples include: actions for a single employee: make sure that the helmet you picked up matches you in size and is intact; shut close valve R544; evacuate to first floor, actions for a group of employees: scan the floor for harmed, injured or unconscious people; communicate within the team where will each one stand when John will start the mixer; actions which involve an employee and a machine: the thermal chamber will automatically lower the temperature to 180 C, please apply a conductivity test to the sample before proceeding to next steps; actions which involve introduction of new procedures: please note that based on reporting of many employees, it is forbidden to bring your cellular phone to the control room.

Specifically, the risk-mitigating action may be determined based on various parameters, which may include for example, the history of one or more employees, possibly including the second employee or other employees from the second set of employees. For example, The generating of the briefing information for the second employee may be preceded by retrieving from a database (e.g., database 120) safety-related historical data pertaining to the second employee, and the determining of the new action may further be based on the safety-related historical data pertaining to the second employee. Moreover, the risk-mitigating action may be determined based on various parameters, which may include for example, the qualifications of one or more employees, possibly including the second employee or other employees from the second set of employees. For example, the generating of the briefing information for the second employee may be preceded by retrieving from a database (e.g., database 120) employee information of the second employee indicative of at least one of: health parameters, professional qualifications, reviews (e.g., by superior or by safety managers). The determining of the new risk-mitigation action in such case may further be based on the employee information of the second employee.

It will this be clear that method 1400 (and system 100) may determine different risk-mitigating actions, instructions and so forth for different employees while executing the same task (or the same type of task). For example, if the second task is performed by a group of three people doing basically the same work, the debriefing information may nevertheless ask one of them to take an active action, another one to read relevant safety data off his handheld communication device, and a third one to leave. Such a decision may be based, for example, on the different qualifications of the three people, on their different health conditions, on the ways they performed in prior case or in prior safety drills, and so on.

It is noted that the determining of the at least one new action for mitigating the new safety-related risk at step 14100 may be assisted by one or more people being involved in that decision making. For example, step 14100 may include receiving mitigating action information from a safety supervisor using a third computer (e.g., in a control room, on their handheld communication device, and so on). This may include, for example, asking a safety supervisor or a manager to address the issue, asking a safety supervisor or a manager to confirm the additional action, etc. The involved person may be on site, in the industrial environment, but may also be located elsewhere (e.g., in headquarters in a different country).

In some embodiments, method 1400 may include presenting to different first employees debriefing questionnaires pertaining to the execution of plurality of different first tasks (of one or more types), and the determining of the new safety-related risk may include determining the new safety-related risk based on synergetic processing of the debriefing responses of the different first employees (e.g., which is not identifiable from a single employee's response). In other embodiments, method 1400 may include processing the debriefing responses (of one or more employees) to generate new debriefing data, different than debriefing data which was used for the presenting of the debriefing questionnaire pertaining to the execution of the first task; and following completion of the second task by the second group of employees, presenting to the second employee a second debriefing questionnaire which is based at least partly on the new debriefing data, wherein the first task and the second task are of the same type of task.

Referring to method 1400 as a whole, it is noted that any one or more steps of process 500 may be combined as part of method 1400, mutatis mutandis, even if not explicitly elaborated in consideration of brevity and clarity of the disclosure. Likewise, any actions discussed above with respect to system 100 may be incorporated as part of method 1400, mutatis mutandis, even if not explicitly elaborated in consideration of brevity and clarity of the disclosure.

FIG. 15 illustrates a part of a debriefing for an employee on a user interface of a handheld communication device 105C, in accordance steps 1430 and 1440 of FIG. 14. Diagram 1502 illustrates presenting to the employee data pertaining to the task they performed (e.g., the first task). The data may include location data, or any other type of data. The presented data may be static or interactive. For example, in the illustrated example, selection of any of the numbers “1”, “2”, or “3” by the employee is followed by presenting to the employee debriefing information related to a location associated with the selected number. Diagram 1504 illustrates an example of a questionnaire which is part of the debriefing information. As can be seen, some of the questions may be open question on which the employee is requested to answer in natural language. The answers of the employee are processed by as part of step 1440 (e.g., server 115) by applying natural language processing (NLP) and/or by involving a human in the analysis process. Diagram 1506 illustrated an example of a debriefing interface which is intended to get the assistance of the employee in identifying suitability of the protocol planned for the task to the events which actually occurred in practice. The employee is presented with options to comment on existing steps of the task protocols, and to suggest new steps. For example, the employee may suggest that prior to shutting down a machine for maintenance, someone should perform a visual examination to verify that the machine is empty from processed material, which may cause damage if not cleared by the machine before shutdown. Diagram 1508 illustrates another example of a user interface of the debriefing process.

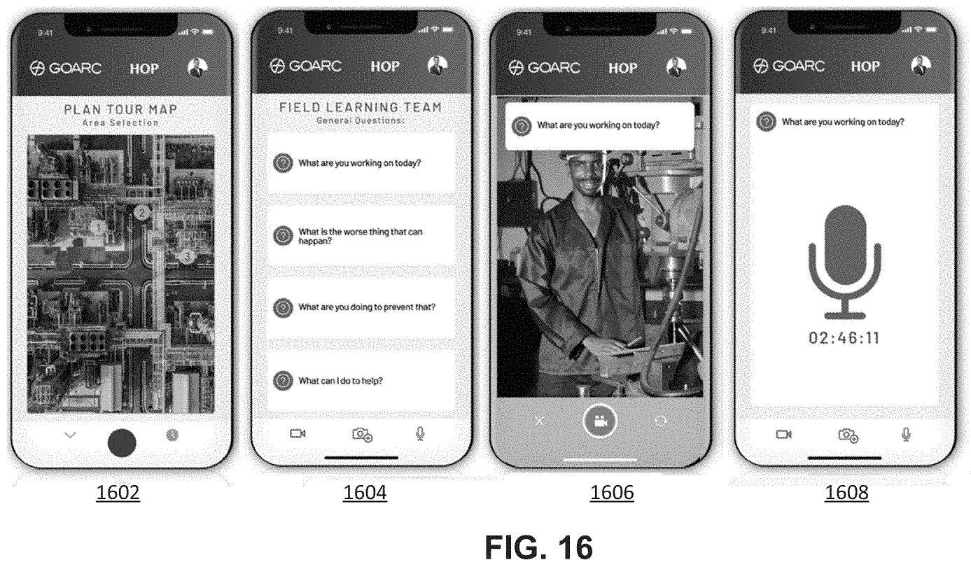

FIG. 16 illustrates a part of a briefing for an employee on a user interface of a handheld communication device 105C, in accordance with examples of the presently disclosed subject matter. The briefing data may include both data which should be made available to the employee prior to their embarking on a task (whether routine data or real-time data relevant to recent changes in the industrial environment), and questionnaire intended to verify that the employee understands what they are about to encounter, and how to properly respond. The briefing includes safety-related aspects, but may also include other aspects (e.g., relating to efficient execution of the task).

Diagram 1602 illustrates presenting to the employee data pertaining to the task they are about to perform (e.g., the second task). The data may include location data, or any other type of data. The presented data may be static or interactive. For example, in the illustrated example, selection of any of the numbers “1”, “2”, or “3” by the employee is followed by presenting to the employee debriefing information related to a location associated with the selected number. Diagram 1604 illustrates an example of a questionnaire which is part of the briefing information. As can be seen, some of the questions may be open question on which the employee is requested to answer in natural language. The answers of the employee are processed by as part of step 1440 (e.g., server 115) by applying natural language processing (NLP) and/or by involving a human in the analysis process. Diagram 1606 illustrated an example of a briefing interface in which the employee can interact with (e.g., answer the questionnaire) by audio/video of them recorded by a microphone and/or camera (e.g., on the handheld communication device 105c). Video and/or audio data may also be presented to the employee via a similar user interface. Diagram 1608 illustrates another example of a user interface of the briefing process.

Referring to the nonlimiting examples of FIGS. 15 and 16, it is noted that optionally at least one of the debriefing of the first employee (or any other employee) and the briefing of the second employee (or any other employee) may be executed using a dedicated chatbot operable to parse natural language response of the respective user. In some embodiments, the briefing of the employee prior to embarking on the task and hand may also provide the employee with option to ask for clarification or other data requested by them, even if not originally included as part of the briefing. Such clarifications, answers or additional data may be provided automatically by the system (e.g., by querying server 115, database 120), but may also include requesting information for a person such as a supervisor, safety supervisor, manager, etc. The briefing of the employee prior to the beginning of the second task may also allow the employee to provide ideas, suggestions, or other information which may affect the execution of the second task, of safety-risk assessment pertaining to the second task or objects associated with it, and so on. For example, the employee may indicate that they or another employee are not feeling well, that they noticed that one of the machines behaves in a suspicious manner, and so on. Such information may affect the planning, scheduling and/or briefing associated with the second task—or even other tasks (e.g., at the same location).

Consistent with the present disclosure, safety management system 100 may be adaptable to changing risks in an industrial environment. Specifically, safety management system 100 may use network interface 206, processing device 202 and memory device 234 to implement method 1400.

Network interface 206 may connect system 100 to external system (e.g., sensors, user interfaces, etc.). Specifically, network interface 206 is configured at least to: (a) receive from a plurality of sensors in the industrial environment task execution information pertaining to an execution of a first task in the industrial environment by a first set of employees including a first employee; and (b) receiving details of a second task scheduled to take place in the industrial environment by a second set of employees including a second employee. Memory device 234 is configured to store data associated with the industrial environment. Specifically, memory device 234 may store, update, modify and/or delete any type of information discussed above with respect to method 1400, as well as any software modules and other software instructions required for execution of any one or more of the steps of method 1400.

Processing device 202 (which may optionally be implemented as a plurality of processors, interconnected or not) is configured to execute any one or more steps (e.g., by reading the relevant instructions from a nonvolatile storage medium of memory device 234). Specifically, processing device 202 is configured at least to: following a completion of the first task, control presentation of a debriefing questionnaire pertaining to the execution of the first task to the first employee; obtaining from a first communications device debriefing-responses of the first employee to the debriefing questionnaire; processing the debriefing responses to determine a new safety-related risk for at least one object associated with the industrial environment used during the execution of the first task, wherein the object includes at least one of: an employee, a tool, a machine, a vehicle, a material; updating a safety database to include data pertaining to the new safety-related risk for the at least one object used during the execution of the first task; determining that execution of the second task involves usage of the at least object used during the execution of the first task; retrieving from the safety database the data pertaining to the new safety-related risk for the at least one object; determining at least one new action for mitigating risks in the execution of second task based on the retrieved data; generating for the second employee briefing information for the second task that includes new briefing data indicative of the determined action; and control a presentation of the briefing information to the second employee using a second communications device.

Consistent with the present disclosure, processing device 202 may be configured to generate a visual representation of the actual execution of the first task relative to an expected execution of the first task, where the visual representation of the actual execution of the first task is based on the task execution information from the plurality of sensors in the industrial environment and the debriefing-responses of the first employee to the debriefing questionnaire. In one embodiments, processing device 202 may be configured to determine the new safety-related risk based on processing of the debriefing responses of the first employee together with the task execution information received from the plurality of sensors in the industrial environment. System 100 may use various machine learning or deep learning techniques to determine the new safety-related risk. In another embodiment, processing device 202 may be configured to generate synergetic risk assessment data by assessing the task execution information in response to new information received from the first employee during the debriefing and determining the new safety-related risk based on the synergetic risk assessment data.

Processing device 202 may also be configured to generate the briefing information for the second employee that includes new questions relating to the new safety-related risk and understanding verification data for verifying that answers of the second employee reflect understanding of the new safety-related risk. In related embodiments, processing device 202 may be configured to implement and/or to support a dedicated chatbot for at least one of the debriefing of the first employee and the briefing of the second employee, the dedicated chatbot being operable to parse natural language response of the respective user. It is noted that the chatbot may also be implemented on the first computer and/or the second computer. Optionally, the first computer includes a plurality of sensors for monitoring execution of the first task, wherein the task execution information comprises information collected by the sensors of the first computer. Optionally, the second computer includes a plurality of sensors for monitoring execution of the second task, wherein the method further comprises monitoring execution of the new action based on data collected by the sensors of the second computer.

In accordance with the present disclosure, the execution of the second task may start before the completion of the first task, and processing device 202 may be configured to generate and control presentation of the briefing information for the second employee after the start of the second task, for mitigating safety-risks of the second task. Specifically, processing device 202 may be configured to control presenting to different employees different first employees debriefing questionnaires, the different questionnaires pertaining to the execution of plurality of different first tasks, and to determine the new safety-related risk based on synergetic processing of the debriefing responses of the different first employees.

Processing device 202 may be configured to retrieve from a database safety-related historical data pertaining to the second employee, and to determine of the new action further based on the safety-related historical data pertaining to the second employee. Optionally, processing device 202 may be configured to retrieve from a database employee information of the second employee indicative of at least one of: health parameters, professional qualifications, reviews, and to determine the new action further based on the employee information of the second employee. System 100 may use various machine learning or deep learning techniques to determine the new action. Additionally, processing device 202 may be configured to process the debriefing responses (of one or more employees) for generating new debriefing data, different than debriefing data which was used for the presenting of the debriefing questionnaire pertaining to the execution of the first task. In such case, following completion of the second task by the second group of employees, processing device 202 may be configured to control presenting to the second employee a second debriefing questionnaire which is based at least partly on the new debriefing data, wherein the first task and the second task are of the same type of task.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A method for adapting a safety management system to changing risks, the method comprising:
receiving from a plurality of sensors in an industrial environment task execution information pertaining to an execution of a first task in the industrial environment by a first set of employees including a first employee;
following a completion of the first task, presenting to the first employee a debriefing questionnaire pertaining to the execution of the first task;
obtaining from a first communications device debriefing-responses of the first employee to the debriefing questionnaire;
processing the debriefing responses to determine a new safety-related risk for at least one object associated with the industrial environment used during the execution of the first task, wherein the object includes at least one of: an employee, a tool, a machine, a vehicle, a material;
updating a safety database to include data pertaining to the new safety-related risk for the at least one object used during the execution of the first task;
receiving details of a second task scheduled to take place in the industrial environment by a second set of employees including a second employee;
determining that execution of the second task involves usage of the at least object used during the execution of the first task;
retrieving from the safety database the data pertaining to the new safety-related risk for the at least one object;
determining at least one new action for mitigating risks in the execution of second task based on the retrieved data;
generating for the second employee briefing information for the second task that includes new briefing data indicative of the determined action; and
presenting to the second employee the briefing information using a second communications device.

2. The method according to claim 1, further comprising: generating a visual representation of the actual execution of the first task relative to an expected execution of the first task, wherein the visual representation of the actual execution of the first task is based on the task execution information from the plurality of sensors in the industrial environment and the debriefing-responses of the first employee to the debriefing questionnaire.

3. The method according to claim 1, further comprising: determining the new safety-related risk based on processing of the debriefing responses of the first employee together with the task execution information received from the plurality of sensors in the industrial environment.

4. The method according to claim 1, wherein the processing comprises generating synergetic risk assessment data by assessing the task execution information in response to new information received from the first employee during the debriefing and determining the new safety-related risk based on the synergetic risk assessment data.

5. The method according to claim 1, wherein the generating of the briefing information for the second employee comprises generating the briefing information for the second employee that includes new questions relating to the new safety-related risk, and understanding verification data for verifying that answers of the second employee reflect understanding of the new safety-related risk.

6. The method according to claim 1, wherein at least one of the debriefing of the first employee and the briefing of the second employee is executed using a dedicated chatbot operable to parse natural language response of the respective user.

7. The method according to claim 1, wherein the first computer comprises a plurality of sensors for monitoring execution of the first task, wherein the task execution information comprises information collected by the sensors of the first computer.

8. The method according to claim 1, wherein the second computer comprises a plurality of sensors for monitoring execution of the second task, wherein the method further comprises monitoring execution of the new action based on data collected by the sensors of the second computer.

9. The method according to claim 1, wherein execution of the second task starts before the completion of the first task, wherein the generating and the presenting of the briefing information for the second employee is executed after the start of the second task, for mitigating safety-risks of the second task.

10. The method according to claim 1, wherein the new action is a risk-mitigating action to be executed by the second employee.

11. The method according to claim 1, wherein the new action is a risk-mitigating action to be executed by an automated machine in the industrial environment.

12. The method according to claim 1, comprising presenting to different first employees debriefing questionnaires pertaining to the execution of plurality of different first tasks, wherein the determining of the new safety-related risk comprises determining the new safety-related risk based on synergetic processing of the debriefing responses of the different first employees.

13. The method according to claim 1, wherein the generating of the briefing information for the second employee is preceded by retrieving from a database safety-related historical data pertaining to the second employee, wherein the determining of the new action is further based on the safety-related historical data pertaining to the second employee.

14. The method according to claim 1, wherein the generating of the briefing information for the second employee is preceded by retrieving from a database employee information of the second employee indicative of at least one of: health parameters, professional qualifications, reviews; wherein the determining of the new action is further based on the employee information of the second employee.

15. The method according to claim 1, further comprising:
processing the debriefing responses to generate new debriefing data, different than debriefing data which was used for the presenting of the debriefing questionnaire pertaining to the execution of the first task;
following completion of the second task by the second group of employees, presenting to the second employee a second debriefing questionnaire which is based at least partly on the new debriefing data, wherein the first task and the second task are of the same type of task.

16. A safety management system adaptable to changing risks in an industrial environment, the system comprising:
a network interface configured to: (a) receive from a plurality of sensors in the industrial environment task execution information pertaining to an execution of a first task in the industrial environment by a first set of employees including a first employee; and (b) receiving details of a second task scheduled to take place in the industrial environment by a second set of employees including a second employee;
a memory configured to store data associated with the industrial environment;
at least one processor configured to:
following a completion of the first task, control presentation of a debriefing questionnaire pertaining to the execution of the first task to the first employee;
obtaining from a first communications device debriefing-responses of the first employee to the debriefing questionnaire;
processing the debriefing responses to determine a new safety-related risk for at least one object associated with the industrial environment used during the execution of the first task, wherein the object includes at least one of: an employee, a tool, a machine, a vehicle, a material;
updating a safety database to include data pertaining to the new safety-related risk for the at least one object used during the execution of the first task;
determining that execution of the second task involves usage of the at least object used during the execution of the first task;
retrieving from the safety database the data pertaining to the new safety-related risk for the at least one object;
determining at least one new action for mitigating risks in the execution of second task based on the retrieved data;
generating for the second employee briefing information for the second task that includes new briefing data indicative of the determined action; and
control a presentation of the briefing information to the second employee using a second communications device.

17. The system according to claim 16, wherein the processor is further configured to determine the new safety-related risk based on processing of the debriefing responses of the first employee together with the task execution information received from the plurality of sensors in the industrial environment.

18. The method according to claim 16, wherein execution of the second task starts before the completion of the first task, wherein the generating and the presenting of the briefing information for the second employee is executed after the start of the second task, for mitigating safety-risks of the second task.

19. The method according to claim 16, comprising presenting to different first employees debriefing questionnaires pertaining to the execution of plurality of different first tasks, wherein the determining of the new safety-related risk comprises determining the new safety-related risk based on synergetic processing of the debriefing responses of the different first employees.

20. The method according to claim 16, wherein the generating of the briefing information for the second employee is preceded by retrieving from a database safety-related historical data pertaining to the second employee, wherein the determining of the new action is further based on the safety-related historical data pertaining to the second employee, or retrieving from a database employee information of the second employee indicative of at least one of: health parameters, professional qualifications, reviews; wherein the determining of the new action is further based on the employee information of the second employee.
